(19) United States
(12) Patent Application Publication
(10) Pub. No.: US 2025/0181030 A1
(43) Pub. Date: Jun. 5, 2025

(54) HOLOGRAPHIC DISPLAY SYSTEM AND METHOD FOR EXPANDING A DISPLAY REGION

(71) Applicant: VividQ Limited, London (GB)

(72) Inventors: Christian FIELDHOUSE, London (GB); Alfred James NEWMAN, London (GB); Darius Martin SULLIVAN, London (GB)

(21) Appl. No.: 19/043,199

(22) Filed: Jan. 31, 2025

Related U.S. Application Data
(63) Continuation of application No. PCT/GB2023/052033, filed on Aug. 1, 2023.

(30) Foreign Application Priority Data
Aug. 2, 2022 (GB) 2211261.9

(51) Int. Cl. G03H 1/22

(52) U.S. Cl. CPC G03H 1/2205; G03H 2001/2207; G03H 2223/55; G03H 2225/24

(57) ABSTRACT

A spatial filter for positioning in a Fourier plane of a holographic display system. The spatial filter delimits a set of apertures, wherein each aperture in the set of apertures is switchable between a substantially transmissive and a substantially non-transmissive state. The set of apertures comprises a plurality of subsets of apertures, and each subset comprises at least one aperture. Each of the subsets of apertures corresponds to a Fourier transform of a target light field, F(H), wherein F(H) substantially does not overlap a Fourier transform of a complex conjugate of the corresponding target light field, F(H*), in the Fourier plane. The union of the set of apertures forms a shape which is at least one of simply connected and substantially space filling.

### CROSS-REFERENCE TO RELATED APPLICATIONS

This application is a continuation under 35 U.S.C. § 120 of International Application No. PCT/GB2023/052033, filed Aug. 1, 2023, which claims priority to GB Application No. GB2211261.9, filed Aug. 2, 2022, under 35 U.S.C. § 119(a). Each of the above-referenced patent applications is incorporated by reference in its entirety.

### TECHNICAL FIELD

The present invention relates to holography and methods of generating holographic images.

### BACKGROUND

Display systems capable of showing images with a continuous range of depths are collectively known as light field displays. Such displays may broadly employ a Computer Generated Holography (CGH) technique. A well-known problem in CGH is that the technique typically yields displays with a rather small eyebox. As used herein, an “eyebox” defines pupil positions in which an image can be viewed; the volume in which a viewer's pupil can be positioned to view an image from an image source. In order to view the image, the viewer's pupil must be located within the eyebox, which may be not much larger than the pupil itself. This presents a challenge to align the eyebox with the viewer's pupil.

Some display systems include mechanical adjustment to physically move the eyebox and align it with the viewer's pupil, for example adjusting an Interpupillary Distance (IPD) on a head-mounted display or mechanically adjusting position of a heads-up display so that it can be seen by a viewer. Other displays are custom made for a particular user; the Focals 1.0 commercially available by North® are designed to align the eyebox of the display system with the viewer's pupil following a custom fitting procedure. Such hardware methods are typically not scalable or require significant effort on the part of the viewer in order to correctly align the eyebox with the pupil. Use of the display system by more than one user also requires time consuming re-adjustment or is simply not possible.

To address the alignment problem outlined above, it may be more appropriate to expand the size of the eyebox. One approach is to enlarge the eyebox using an image-replicating combiner, also known as a waveguide combiner. This expands the size of the eyebox provided by an image source by generating multiple spatially separated replications of the input image. The viewer's pupil can then be located in a larger area and still view a complete image. However, image-replicating combiners suffer from reduced image quality due to problems such as focus spread.

Another approach for expanding the size of the eyebox involves using a modulator having a suitably high modulation speed to display light fields at different positions in quick succession so that the viewer perceives one larger image due to persistence of vision. Examples of such modulators are digital micromirror devices (DMDs) and liquid crystal on silicon (LCoS) devices. However, in practice, these types of displays cannot achieve the perfect full-complex modulation required to generate a perfect holographic image because they only have a very limited number of values they can display. For example, these displays may only be capable of modulating one of amplitude or phase. The resolution may also be limited, perhaps to 5 bits of resolution (giving 32 possible displayed values or fewer), even only 2 values in the case of a binary display technology.

As a result, pixels of a full-complex holographic image are quantised for display, to a value that can be reproduced by the display. For example, in the extreme case of a binary display (such as a DMD) each pixel in the display can only be in one of two states. All points on the full-complex Argand diagram need to be mapped to one of the two states. The process of quantisation for display therefore reduces the image quality, visible in the perceived image as reduced contrast and/or noise.

It would be desirable to be able to expand the field-of-view possible with such CGH displays while also improving the image quality of the generated holographic images.

### SUMMARY

According to a first aspect of the present invention, there is provided a spatial filter for positioning in a Fourier plane of a holographic display system. The spatial filter delimits a set of apertures, wherein each aperture in the set of apertures is switchable between a substantially transmissive and a substantially non-transmissive state. The set of apertures comprises a plurality of subsets of apertures, each subset comprising at least one aperture, and each of the subsets of apertures corresponds to a Fourier transform of a target light field, F(H), wherein F(H) substantially does not overlap a Fourier transform of a complex conjugate of the corresponding target light field, F(H*), in the Fourier plane. The union of the set of apertures forms a shape which is at least one of simply connected and substantially space filling. “Simply connected” is used in its mathematical sense to mean a shape which is free of holes, gaps or other discontinuities; a simply connected shape is one in which any simple closed curve can be shrunk to a point continuously in the shape. A “simple closed curve” is used in its mathematical sense to mean a connected curve that does not cross itself and ends at the same point it begins. Furthermore, despite the name “curve”, a simple closed curve does not have to curve and can incorporate, or be formed entirely of, straight sections. A “substantially space filling” shape generally does not have holes, gaps or apertures within its perimeter. A substantially space filling shape may fill greater than 90%, greater than 95%, greater than 98% or greater than 99% of an area inside a perimeter of the shape. It is understood that a subset of apertures may include one or more apertures.

The effective area in which the hologram can be viewed can be increased using such a spatial filter because the union of apertures forming a space-filling or simply connected shape allows for an increase in the eyebox coverage. The continuity of the shape reduces the chance of a path between two eye-pupil positions in the eyebox being interrupted by a gap in the shape. Furthermore, as will be explained in more detail later, the inventors have realised that noise introduced by quantisation for display results in additional components in the Fourier plane that are approximated by a series expansion. By considering the F(H*) term of the series expansion and ensuring that it does not overlap with F(H) so that F(H*) is blocked by the spatial filter, higher image quality can be obtained. By F(H) it is meant the part of the Fourier transform which has non-zero values.

Determining a target light field, H, satisfying this non-overlapping condition is computationally simpler than prior iterative methods, such as Gerchberg Saxton, reducing requirements for processing resources. This can allow higher quality holographic displays having larger addressable eyeboxes with reduced processing and/or power requirements, allowing displays to be one or more of: lower-cost, more portable, and for battery-powered devices, increased battery life. This lower processing and or power requirement can enable a plurality of target light fields to be generated in a time-sequence at high frequency. Each of the time sequence of F(H) may correspond to a respective one of the plurality of subsets of apertures of the spatial filter, in substantial synchrony with a respective one of the plurality of subsets of apertures of the spatial filter being in a substantially transmissive state. As discussed above, through persistence of vision, this means that the viewer effectively views an image covering a larger area and thus, the effective size of eyebox is increased while at the same time improving image quality of the image.

The shape may be a simple polygon. That is, the shape may be a polygon that does not intersect itself and has no holes. In some cases, the shape is one that can be substantially tessellated. The shape may be a shape that periodically tessellates to a two-dimensional plane. When the shape can be substantially tessellated the spatial filter may delimit a plurality of such sets of apertures. Each set may then be arranged on the spatial filter such that at least a portion of the spatial filter is tessellated by the shapes, allowing an even greater expansion of the addressable eyebox.

The shape may be substantially tessellated on a rhombic grid. This provides a particular advantage when a holographic light field is transmitted via an image replicating combiner that is configured to generate replications of the light field on a rhombic grid because the image replicating combiner can replicate the shape to provide near-continuous coverage over an expanded phase volume, thereby increasing the coverage of the addressable eyebox of the display system.

In some examples, the shape is dodecagonal. The shape may have a two-fold symmetry, such as a two-fold rotational symmetry or a two-fold axis of symmetry. The shape may substantially have the form of an “I” or “H”. The “I” or “H” shape might be dodecagonal, such as corresponding to an “I” in a serif font and an “H” in a sans serif font. At least one of the apertures of the set of apertures may be a quadrilateral.

In some examples, at least one of the subsets of apertures corresponds to a Fourier transform of a first target light field, F(H) and further does not substantially overlap (i) a Fourier transform of the first target light field multiplied by the complex conjugate of the target light field, F(HH*), (ii) a Fourier transform of a square of the target light field, F(H²), and (iii) a Fourier transform of a square of the complex conjugate of the light field F(H*²). The energy in the series expansion tends to be concentrated in lower order terms, so ensuring no overlap with at least F(H*) is useful, but the next higher order terms such as F(HH*), F(H²) and F(H*²) also contain reasonable amounts of energy so that blocking these is also useful. A union of apertures, wherein all of the subsets of apertures satisfy this additional non-overlapping condition, cannot also satisfy the simply connected criterion (that the union has no holes or apertures). However, a spatial filter delimiting a combination of subsets of apertures satisfying both the weaker and stronger non-overlapping conditions can also satisfy the simply connected criterion. This can allow a good balance of image quality and coverage.

A subset of apertures may have an area approximately ⅙^{th} of an area of a square on the grid formed by integer diffraction orders of light having a predetermined wavelength incident on a modulator. A ⅙^{th} area is understood to set a limit on the maximum size of the aperture (or subset of apertures) which can meet the stronger non-overlapping constraint whereby F(H) does not overlap with first and second order terms of its Fourier expansion: F(H*), F(HH*), F(H²) and F(H*²).

According to a second aspect of the invention, there is provided a holographic display system. The holographic display system comprises a light source configured to emit at least partially coherent light, a modulator arranged to be illuminated by the at least partially coherent light and to generate a time sequence of light fields, wherein each of the light fields is a quantised representation of a target light field. The holographic display system further comprises a spatial filter according to the first aspect, in a Fourier plane.

The modulator may be a digital micromirror device (DMD). DMDs have certain advantages for displaying holograms such as allowing an improved (darker) black level. In particular, they feature high modulation speeds, typically much higher than 1000 binary patterns per second. Such high modulation speeds allow the time sequence of light fields to be generated fast enough that a viewer will perceive such a series of rapidly displayed light fields as a single hologram, through persistence of vision. In other examples, the spatial light modulator is a Liquid Crystal on Silicon, LCoS, device. Although LCoS devices may have more quantisation states than a DMD, useful increases in image quality are also achieved using the methods described herein.

As mentioned above, generating a time sequence of light fields in substantial synchrony with a respective one of the plurality of subsets of apertures of the spatial filter being in a substantially transmissive state can increase the size of the eyebox of the display system.

The spatial filter may be positioned so that the union of the set of apertures substantially aligns with a peak diffraction efficiency of the modulator. This may increase the amount of light that can be transmitted by the spatial filter. The light source may be configured to emit at least partially coherent light at a plurality of wavelengths selected so that the peak diffraction efficiency of the modulator approximately aligns in at least one direction with an integer diffraction order for each of the plurality of wavelengths. The plurality of wavelengths may comprise red, green and blue light, and the peak diffraction efficiency for each of red, green and blue light may be aligned with a different integer diffraction order. In some examples, the DMD is configured such that the landed edge of an “on-state” mirror is horizontal i.e. parallel to the long side of the DMD. In this case, the peak diffraction efficiency may be approximately aligned with the 5th, 6th and 7th vertical diffraction orders for red, green and blue respectively. Red may have a wavelength between 620 nm-750 nm such as 635 nm. Blue light may have a wavelength around 450 nm-495 nm, for example, 450 nm. Green light may have a wavelength in the range of 495-570 nm or in the range of 520-560 nm, such as around 520 nm.

The holographic display system may further comprise an image replicating combiner positioned in an optical path after the spatial filter and a processing system coupled to the modulator. The processing system may be configured to: determine a light field to be displayed at a viewing location (for example the location of the eye pupil within the addressable eyebox of the image replicating combiner); determine a transfer function describing the propagation of light through the image-replicating combiner between the viewing location and the Fourier plane which may be near to an input surface of the image-replicating combiner; determine an input light field by applying the determined transfer function to the light field at the viewing location, wherein the input light field corresponds to the union of the set of apertures, determine the plurality of F(H) corresponding to each of the subsets of apertures to be displayed at the Fourier plane, and cause the modulator to generate each of the plurality of F(H) at the input location. Image replicating combiners are known to provide a large addressable eyebox by generating a plurality of replications of an input light field. This larger addressable eyebox can be utilised with a spatial filter according to the first aspect to improve the eyebox coverage available from the display system. Furthermore, the transfer functions allow images to be precisely targeted at a particular viewing position, reducing common problems associated with image replicating combiners for holographic images, such as focus spread. The input surface of the image-replicating combiner may be substantially in the Fourier plane, within a short distance of the Fourier plane such as 1 mm and 2 mm, or positioned right up against the spatial filter.

The union of apertures in the Fourier plane is essentially the exit pupil of the holographic display system. With the addition of an image replicating combiner, the exit pupil can be replicated to further increase the addressable eyebox of the holographic display system. The plurality of replications may approximately tesselate in a plane when viewed from at least one viewing position. In some examples, a “viewing position” may mean any viewing position within the addressable eyebox of the display system. This is particularly advantageous when the union of the set of apertures of the spatial filter forms a shape which tessellates. A plurality of such sets, replicated by the image-replicating combiner, provide near-continuous coverage over an expanded phase volume, thereby increasing the coverage of the addressable eyebox, meaning that a larger range of eye positions may be addressed. The tessellation may be approximately exact for a single viewing angle.

The holographic display system may further comprise an eye-tracking system arranged to provide data indicative of a viewing position to the processing system. The data may be used by the processor to generate light fields which can be displayed at the determined viewing position(s). Furthermore, due to the expanded size of eyebox of the holographic display system, the holographic display system may not require mechanical adjustment to accommodate a plurality of users having a range of interpupillary distances.

The light source may be configured to emit at least partially coherent light at a plurality of wavelengths, including green light, and the subset of apertures correspond to positions of respective F(H) for green light. Such subsets of apertures will approximately correspond to positions of respective F(H) for blue and red light, but the overall error across all colours is reduced compared to aligning the apertures with F(H) for blue or red light.

The holographic display system may comprise a controller configured to cause the modulator to display a time sequence of quantised target light fields, each of the time sequence of quantised target light fields corresponding to a respective one of the plurality of subsets of apertures, in substantial synchrony with the respective one of the plurality of subsets of apertures of the spatial filter being in a substantially transmissive state. This allows a viewing eyebox to be expanded by time-multiplexing multiple apertures of spatial filter.

According to a third aspect of the invention, there is provided a method of displaying a holographic image. The method comprises: determining a first light field, H₁, for quantisation, the first light field having a Fourier transform, F(H₁), such that it does not overlap a Fourier transform of its complex conjugate, F(H₁*); determining a second light field, H₂, for quantisation, the second light field having a Fourier transform, F(H₂), such that it does not overlap a Fourier transform of its complex conjugate, F(H₂*); at a first time, displaying a quantised version of the first light field using the holographic display system according to the second aspect, wherein a first subset of apertures corresponds to an extent of F(H₁) in a Fourier plane such that components corresponding to F(H₁*) resulting from quantisation are substantially blocked by the spatial filter; and at a second time, displaying a quantised version of the second light field using the holographic display system according to the second aspect, wherein a second subset of apertures corresponds to an extent of F(H₂) in a Fourier plane such that components corresponding to F(H₂*) resulting from quantisation are substantially blocked by the spatial filter, wherein at the first time, the first subset of apertures allows light to pass and the second subset of apertures prevents (blocks) light from passing, and at the second time, the first subset of apertures prevents (blocks) light from passing, and the second subset of apertures is allowing light to pass. The first and second light fields can be target light fields as described above in that they are the light fields in the plane of a modulator used to generate the light fields. For example, a target light field may be a desired light field before quantisation.

According to a fourth aspect of the invention, there is provided a computer-readable medium comprising instructions, that, when executed by a processor, cause the holographic display system according to the second aspect to display a holographic image according to the fourth aspect.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows an example of the location of the Fourier transform of a hologram, F(H), in the Fourier plane;

FIG. 1B shows the location of F(H*) in the Fourier plane according to the example;

FIG. 1C shows the location of F(HH*) in the Fourier plane according to the example;

FIG. 1D shows the location of F(H²) in the Fourier plane according to the example;

FIG. 1E shows the location of F(H*²) in the Fourier plane according to the example;

FIG. 1F shows a composite of FIGS. 1A-1E illustrating all of the components in the same figure;

FIG. 1G shows the locations of all of the components and all of the copies of the components;

FIGS. 2A and 2B show examples of filters delimiting an aperture;

FIG. 3 shows a further example of a filter delimiting an aperture;

FIG. 4 shows a filter comprising a plurality of portions according to an example;

FIG. 5 shows the peak diffraction efficiency of an example DMD;

FIG. 6 is a photograph corresponding to FIG. 5;

FIG. 7 shows a filter positioned with respect to the peak diffraction efficiency of an example DMD;

FIGS. 8A to 8F show the relative positions of F(H) and F(H*) for several apertures using different colours;

FIG. 8G-8I show overlapping contributions of F(H), F(H*), F(HH*), F(H²) and F(H*²) for green, red and blue light passing through all apertures of the filter shown in FIG. 4;

FIG. 9 is a schematic diagram showing a holographic display system according to an example;

FIG. 10 shows an example of a set of apertures that tessellate on a rhombic grid;

FIG. 11 is a schematic diagram of the operation of an image-replicating combiner;

FIG. 12A is a schematic representation of phase volumes of 2d light fields;

FIG. 12B is a further schematic representation of phase volumes of 2d light fields;

FIG. 13A shows a schematic diagram of an example display system illustrating the geometry of replications generated by an image replicating combiner;

FIG. 13B shows a further schematic diagram of an example display system illustrating the geometry of replications generated by an image replicating combiner;

FIG. 13C shows yet a further schematic diagram of an example display system illustrating the geometry of replications generated by an image replicating combiner; and

FIG. 14 shows a method according to an example.

### DETAILED DESCRIPTION

Holographic images are images with depth information that give the perception to a viewer of depth and can be generated by exploiting the electromagnetic wave nature of light. The term images as used herein is understood to include static images as well as moving holographic images comprising a sequence of holographic frames displayed in rapid succession. Furthermore, the present disclosure is relevant to both 2-dimensional and 3-dimensional holograms.

2-dimensional holograms are those which occupy substantially a single image plane but where the image plane can be positioned at a perceived depth from the user. This can allow more comfortable focussing for a viewer's eye especially in augmented reality situations; the hologram can be given a depth matching a point of interest. 3-dimensional holograms give the appearance of a 3-dimensional scene or object with appropriate depth cues for a viewer's eye.

As will be explained in more detail below, by applying constraints on the position of a desired full-complex hologram, H, so that F(H) occupies a particular position in the Fourier plane where it does not overlap with at least F(H*), spatial filtering in a Fourier plane can be used to reduce quantisation noise. This technique may be applied together with time-multiplexing of a plurality of quantised full-complex holograms targeted to different areas of the Fourier plane to expand an eyebox of a display system. Some examples further expand the eyebox using an image replicating combiner. These may also apply a transfer function to account for a viewing position amongst the replications and reduce problems, such as focus spread, that can be associated with image-replicating combiners when holograms are displayed.

### Reduction of Quantisation Noise Through Spatial Filtering

In CGH, a hologram for display is typically first calculated as a “full-complex” hologram which comprises an array of values corresponding to each element (pixel) on the surface of a display device. Each value is a complex number with respective phase and amplitude. However, many display systems used for CGH images, such as DMD and LCoS spatial light modulators, have a finite range of values that they can reproduce. To display the hologram, each pixel in the full-complex modulated holographic image needs to be mapped, or quantised, to a value that can be reproduced by the display. In one example, the display device is a binary display, capable of generating images comprising pixels taking one of two possible amplitude or phase values. An example binary amplitude display device is a digital micromirror device (DMD) comprising an array of microscopic actuating mirrors. When illuminated by a light source, each mirror can either direct light to the next component in the optical system, representing a pixel “on” state, or direct light elsewhere, such as towards a heat sink, representing an “off” state. Each mirror can be actuated between the two states as required to generate the desired hologram. Similarly, in a binary phase display device, each pixel is capable of emitting light at one of two discrete phases.

Mapping the continuum of full-complex modulated values to quantised amplitude and/or phase values requires a particular quantisation method to be used. A simple example of a binary amplitude quantisation scheme is as follows. If the value has a negative or zero real part (the point is in the second or third quadrant on the Argand diagram), the point is mapped to (0,0) on the Argand diagram. If the value has a positive real component, the point is mapped to the point (0,1) on the Argand diagram. The person skilled in the art will be aware that many alternative quantisation methods can be used and the present disclosure is not limited to any particular quantisation method. However, this example highlights the loss in phase and amplitude information that results from quantising points for display on a DMD. While other display technologies may offer more values, the number of finite states available is still low, perhaps 5 bits (32 values). It is clear that any quantisation will result in a loss of amplitude and phase information, reducing image quality.

The inventors have shown that the noise introduced by quantisation can be reduced by selectively filtering out unwanted noise in the quantised hologram using a physical filter in the display apparatus while also expanding the size of the eyebox of such a display system. By approximating a quantised representation, H_{Q}, of a target light field as a series expansion, a quantised field can be determined in which one or more additional unwanted components introduced by the quantisation can be filtered out in the Fourier domain/Fourier plane, allowing a much improved approximation of the full-complex target field to be displayed despite the quantisation that has taken place in the display system. The display system and method discussed may provide a computationally inexpensive technique for achieving full-complex modulation using conventional display devices, especially compared to prior iterative software-based techniques, such as Gerchberg Saxton.

$${H}_{Q} ≅ a + bH + {cH}^{*} + {dH}^{2} + {eH}^{* 2} + {fHH}^{*} + … \qquad Eq . 1$$

Equation 1 above is an expansion of the quantised target light field, H_{Q}. In addition to the desired component H, additional components, H*, H², H*², HH*, . . . are introduced by the quantisation. a, b, c, d, e and f are scalar coefficients whose values depend on the particular quantisation scheme employed. They can be determined numerically but, for the methods described herein, their determination is not essential. It will be appreciated that, as only the H component is desired, the extent to which the rest of the expansion is considered may vary. For example, only the terms in the expansion with the greatest impact (largest coefficient) may be considered. Some examples may consider further components than those in equation 1, such as a H³ term and so on. Other examples may include fewer components than those in equation 1, such as only the H* term.

The quantised Hologram, H_{Q}, is displayed by quantising the initial full-complex hologram, calculated or determined with known techniques, for display. Any suitable display device can be used, including a Spatial light modulator (SLM). The SLM may be, for example, a DMD, an LCD, an Amplitude LCoS, or a phase LCoS. Alight source is configured to generate at least partially coherent light, which is modulated by the SLM and may be, for example, a laser or a light emitting diode (LED).

The SLM generates a light field which, when observed by a viewer through an optical system, recreates the light field so the image is perceived. Conventional holographic display systems include a lens that creates a Fourier transform of the image displayed on the SLM, with the eye of a viewer causing an inverse Fourier transform to take place. Without applying further steps, such as iterative techniques to account for the quantised values reproducible by the SLM, image quality is low because of the errors introduced by quantisation.

However, the present disclosure makes use of the observation that if a lens having a focal length, f, is positioned one focal length in front of the SLM, such that light modulated by the SLM is incident on the lens, then the Fourier transform of H_{Q}, F(H_{Q}), will be produced one focal length behind the lens. This position is referred to as a Fourier plane of the SLM. This is the plane where the complex amplitude is described by a Fourier transform of the complex amplitude at the SLM, potentially modulo scaling or including a multiplicative spherical phase term. In the present case, the Fourier transform of H_{Q} can be written in terms of the Fourier transform of the series expansion of equation 1 above. Using linearity of the Fourier transform and equation 1, F(Hg) can be expressed as equation 2 below:

$$F ( {H}_{Q} ) = aF ( 1 ) + bF ( H ) + cF ( {H}^{*} ) + dF ( {H}^{2} ) + eF ( {H}^{* 2} ) + fF ( {HH}^{*} ) + … \qquad Eq . 2$$

The components F(H*), F(H²), F(H*²) and F(HH*) will be referred to herein as noise components because they relate to unwanted components generated by quantising the target field, H. It will be understood that the effect of these components could be visible as classical “noise” but could also be a reduction in image contrast and will generally result in reduced image quality.

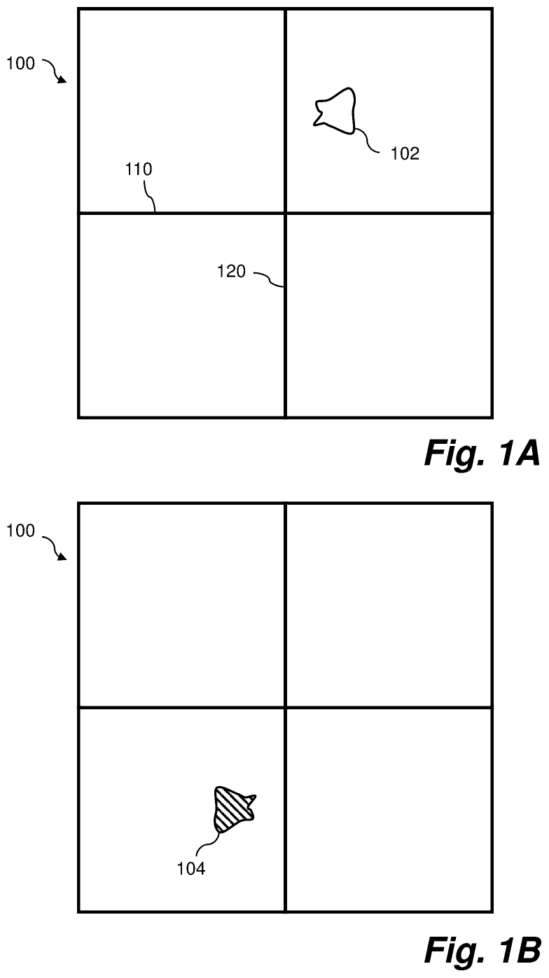

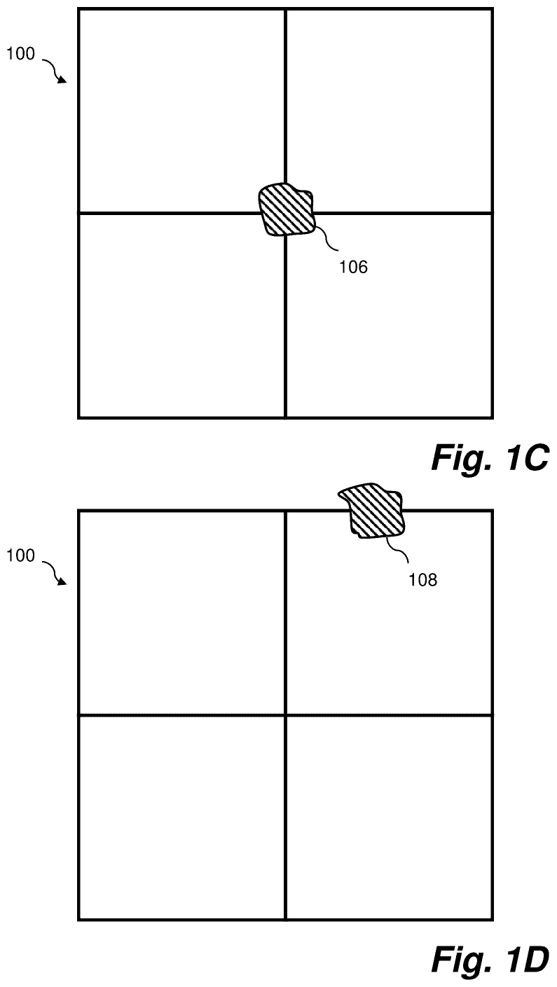

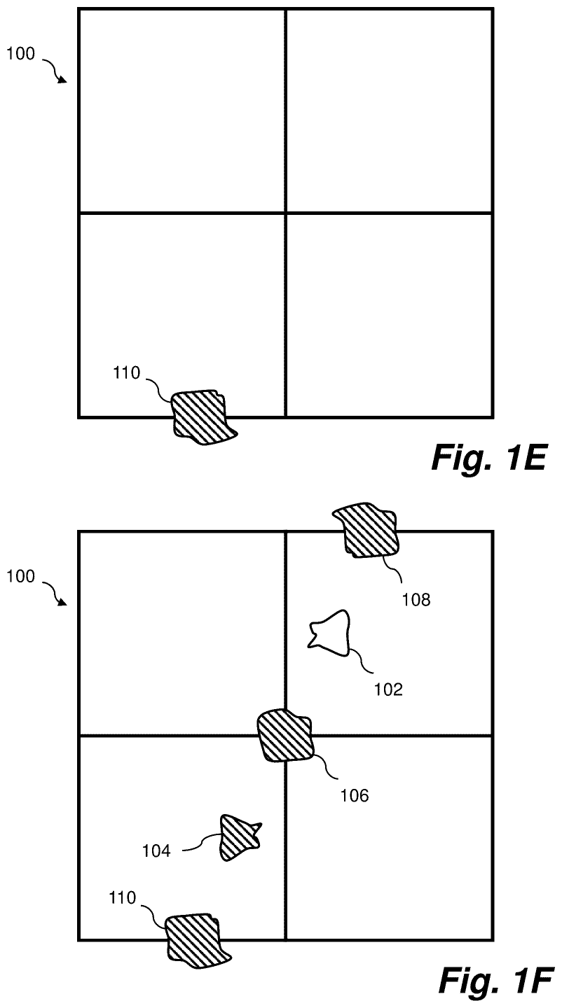

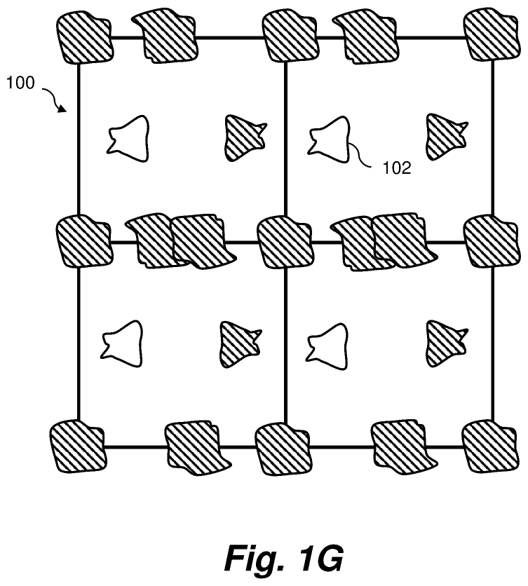

The Fourier transform of a function of space (the target light field, H, is a function of space, H≡H(x,y), for example) decomposes that function into its respective frequency components, kₓ and k_{y}. The Fourier transform of the constant, a, in Eq 1 is a delta function, multiplied by a, and centred at kₓ=k_{y}=0, as represented by the term aF(1) in Eq 2, and sometimes known as the zero-order diffraction peak. The locations of each of the components on the right-hand side of Eq. 2 in the Fourier plane can be determined from knowledge of the location of F(H) as will now be explained with reference to FIGS. 1A to 1G. FIGS. 1A to 1G are for the purposes of illustration of the general principles used in this disclosure, and the relative locations of noise components.

An example of F(H) 102 targeted at an arbitrary area in the Fourier plane is illustrated in FIG. 1A. FIG. 1A is a plot of the Fourier transform of H in spatial frequency space, with the central horizontal line 110 representing the spatial frequency kₓ axis, and the central vertical line 120 representing the spatial frequency k_{y} axis. Equivalently, FIG. 1A is a plot of the Fourier plane with the horizontal line 110 representing the spatial x axis, and the central vertical line 120 representing the spatial y axis. With this definition, each cell in FIG. 1A is a square with sides of dimension λf/p, where λ is the wavelength of the light illuminating the SLM, f is the focal length of the lens, and p is the pixel pitch of the display. FIG. 1A depicts four cells, centred on the origin to show how the tiling of these unit squares influences the aperture design. For example, for illumination with wavelength λ=520 nm, f=60 mm and p=5 μm, the dimension of the square in the Fourier plane is 6.24 mm. Once the position of F(H) in the Fourier plane is known, the position of the Fourier transform of H*, F(H*), can be determined from the position of F(H). Within the Fourier plane, this is a reflection in the line k_{y}=−kₓ. The result is shown in FIG. 1B, as region 104.

Similar spatial plots in the Fourier plane can be made for the higher order components of the expansion. FIG. 1C shows the position of F(HH*) 106 in the Fourier plane 100. F(HH*) is the Fourier transform of the target light field, H, multiplied by its complex conjugate, H*. Thus, F(HH*) resides in the centre of the Fourier plane and is of double extent of H and H* in kₓ and k_{y}. FIG. 1D shows the position of F(H²) 108 in the Fourier plane 100, which is also of double extent of F(H) 102 and F(H*) 104 and centred twice as far from the origin as F(H) 102. FIG. 1E shows the position of F(H*²) 110 in the Fourier plane 100. Similarly, F(H*²) 110 is of double extent of F(H) 102 and F(H*) 104 and centred twice as far from the origin as F(H*) 104.

FIG. 1F is a composite of FIGS. 1A-1E and illustrates the relative positions of each component 102, 104, 106, 108, 110 in the Fourier plane 100. Because the target light field, H, is sampled on a grid of pixels, the fields in the Fourier plane repeat on a grid of the squares forming a repeating pattern of the components 102, 104, 106, 108, 110. FIG. 1G shows each of the components depicted in FIG. 1F as well as each of the copies of the components in the Fourier plane. For the location of F(H) 102, none of the noise components introduced by quantisation that were considered in FIGS. 1B to 1E overlap with F(H). Furthermore, none of the other copies of those additional components created by the sampling on a grid overlap with F(H).

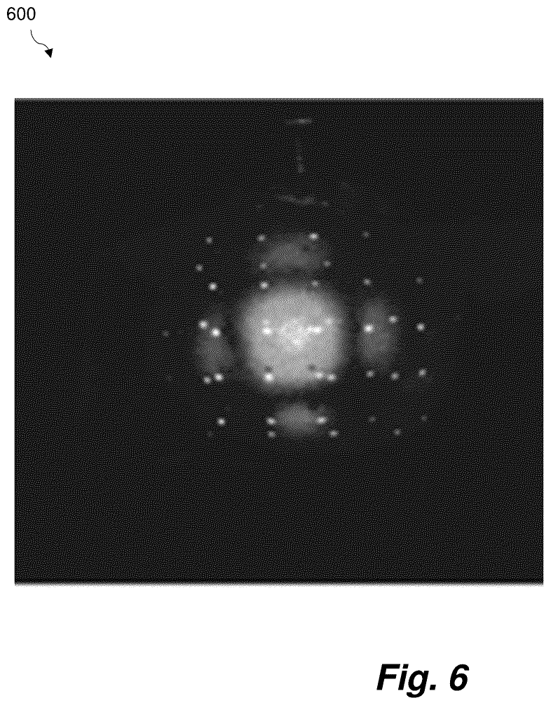

FIG. 1G may be understood to show the grid and repetitions of the field components on any arbitrary region of the Fourier plane. In one example, it may be useful to consider the centre of the Figure to coincide with the zero-diffraction order of the light illuminating the SLM. Some SLM's, such as DMDs, behave like a blazed grating due to the angle that the individual mirrors form with respect to the plane of the DMD when in the on-state, so that their peak diffraction efficiency does not coincide with the location of the zero-diffraction order. In the example shown in FIG. 6, which will be discussed in further detail later, it can be seen that the peak diffraction efficiency of green light in an example DMD occurs approximately level with the 6^{th} diffraction order vertically, and approximately between the 0 and 1st orders horizontally. In such situations, it may be useful to consider the centre of FIG. 1G to coincide with the 6^{th} vertical and 0^{th} horizontal diffraction order.

It will be appreciated how varying the area occupied by F(H) affects the area occupied by each of the noise components. For example, enlarging the area of F(H) in the Fourier plane causes the noise components to grow correspondingly. Once F(H) reaches a sufficient extent, it will begin to overlap with one or more of the noise components. Further, translating and/or rotating F(H) relative to the origin in the Fourier plane will cause a corresponding translation and/or rotation of the noise components.

As can be seen from FIG. 1G, the effect of the noise components considered can be removed with a spatial filter in the Fourier plane. An inverse Fourier transform of the resulting filtered Fourier plane will more closely resemble the original full complex function H than will a Fourier transform of an unfiltered Fourier plane. Such filtering can take place physically as part of the display of a hologram, rather than requiring additional calculation steps, such as the multiple iterations of Gerchberg Saxton. A CGH that targets a particular region of the Fourier plane is relatively easy to determine, such as by applying a masking function. This requires significantly less processing resources and/or power than prior iterative methods.

In an example, the filtering takes place by positioning a spatial filter delimiting an aperture corresponding to the region in the Fourier plane to which F(H) has been targeted. A spatial filter located in the Fourier plane of a lens (for example, where a lens is one focal length from the SLM, the lens's Fourier plane is one focal length at the opposite side), the spatial filter can therefore block one or more of the noise components physically. The aperture allows light corresponding to F(H) to pass through the filter and thus reach a target plane where the hologram can be viewed. Selecting the position of F(H) such that there is no overlap of F(H) with at least one of the considered noise components ensures that light corresponding to F(H) reaches the target plane while blocking the at least one noise components.

As discussed above, once the location of F(H) in the Fourier plane is determined, the locations of the noise components can also be determined, using the method of FIGS. 1A to 1G, for example. Many possible locations of F(H) which do not overlap with one or more considered noise components are possible. Some examples may maximise a region in the Fourier plane subject to the condition that the considered noise components do not overlap F(H). Maximising the region covered by F(H) maximises the amount of light that passes through the filter, increasing the brightness of the hologram at the target plane. This also maximises the area of the hologram in the Fourier plane increasing an area where the hologram can be viewed. The area of the Fourier plane occupied by the hologram corresponds with an “eyebox” of the holographic display system, where a viewer's pupil can be positioned to view the hologram.

### Example Spatial Filter Configurations to Reduce Quantisation Noise

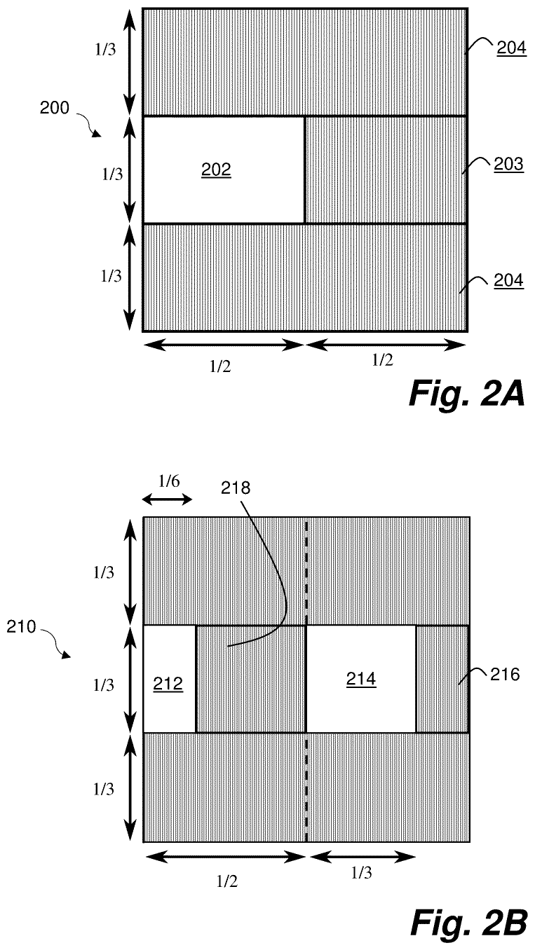

Some example filters will now be discussed. FIGS. 2A and 2B show filters 200, 210, delimiting example apertures 202, 212, 214. The filters 200, 210 are arranged to correspond to a particular F(H) which does not overlap noise components up to the second order. It follows that the maximum area that F(H) can occupy in the Fourier plane, while satisfying the condition of no overlap of noise components relating to F(H*), F(HH*), F(H*²) and F(H²), is ⅙^{th} of the total area of the filter. Further, the shape of the aperture is constrained by the non-overlap condition described above. FIGS. 2A and 2B satisfy this maximal area condition. It can be seen that none of the apertures 202, 212, 214 are circular. This may be because a circle cannot satisfy the maximal area condition as circles can never completely tile a flat 2-dimensional space.

The filters 200, 210 are shown as unit squares with relative side lengths of 1 for illustration purposes, but in reality will have lengths equal to λf/p. FIGS. 2A and 2B show filters delimiting apertures satisfying the condition that, if F(H) is targeted at the apertures, then at least the noise components considered above for FIGS. 1A to 1G are blocked by the non-aperture portions of the filters and also ⅙ of the area of the unit square is used. FIGS. 2A and 2B are just a few of the possible filters that satisfy the above condition. Likewise, in some examples, filters may not seek to occupy a maximal area and may occupy a smaller area that still satisfies the non-overlap condition.

FIG. 2A shows an example filter 200 delimiting a rectangular aperture 202 according to an example. The rectangular aperture 202 extends from a side of the filter, in this case from a vertical side and has a width of ½ the width of the filter 200 and a height of ⅓ the width of the filter. More specifically the region is centred on a vertical axis and located at a left side. The rectangular aperture 202 is positioned such that F(H*), F(H²), F(H*²), and F(HH*) are blocked by the filter. Specifically, F(H*) occupies a region 203 adjacent to the aperture 202 along the horizontal axis and occupying the same extent on the vertical axis. F(HH*), F(H²) and F(H*²) occupy regions 204 extending the full width of the filter 200 above and below the aperture 202.

It will be understood that a reflection of filter 200 about a vertical line extending through a centre of the filter, a reflection about a horizontal line extending through a centre of the filter, rotations of 90° about the centre of the filter, reflections about the axes extending through the origin of the Fourier plane, and rotations of 90° about the origin are also possible and also satisfy the constraint of non-overlapping noise components. For example, as shown in FIG. 2A, an alternative form may have region 203 as the aperture and region 202 blocked.

FIG. 2B shows a filter 210 delimiting two apertures 212, 214. The aperture 212 is rectangular having side lengths of ⅓ and ⅙ the length of the filter. The lower left vertex of the aperture 212 is ⅓ the way up the left edge of the filter 210. The aperture 214 is a square of side length ⅓ the length of the filter. The aperture 214 is positioned such that its lower left vertex is about ½ the way along the base of the filter 210 and ⅓ the way up the filter 210. The lower right vertex is positioned ⅓ the length of the filter to the right of the lower left vertex. The combined area of the apertures 212, 214 is ⅙ the total area of the filter 210. A central vertical dotted line is shown to indicate halfway along the filter 210. The filter 210 still satisfies the condition that if F(H) is simultaneously targeted at the apertures 212, 214, then the extent of F(H) is maximised without there being any overlap with noise components. As in FIG. 2A, FIG. 2B also shows portions of the filter 216, 218 that could alternatively be delimited as apertures to give the same effect as apertures 212, 214 through rotation and/or reflection of the apertures 212, 214. These portions 216, 218 are again indicated by solid lines in the filter 210. Further discussion of filter configurations which do not overlap with noise components up to the second order of the Fourier series expansion are given in PCT patent application publication no. WO2023/002175, having priority date 21 Jul. 2021 and incorporated herein by reference for all purposes.

It will be understood that because components on the Fourier plane repeat in a periodic pattern, the region covered by the filter can be translated on the Fourier plane to produce another filter where aperture 212 could appear on the right of 214. This can be visualised for example by taking the left half of FIG. 2B and placing it adjacent to the right half of FIG. 2B. In this case the two apertures are both entirely located within a horizontal extent that is two thirds of the width of the unit cell.

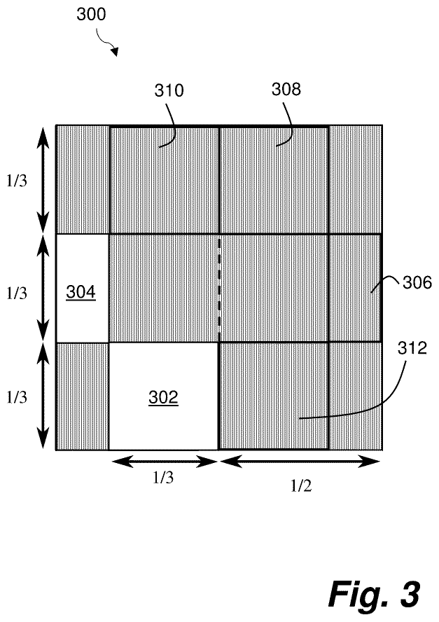

FIG. 3 shows an example filter 300 comprising apertures 302, 304 which, combined, satisfy a slightly weaker non-overlapping condition than the filters 200, 210 shown in FIGS. 2A and 2B. In this example, an F(H) corresponding to the apertures 302, 304 does not overlap F(H*) but does have some overlap with the F(H²), F(H*²), and F(HH*) terms. Therefore, the filter 300 blocks F(H*) but allows some of the higher order noise terms to be transmitted through the filter 300. It has been shown that such an aperture still improves the image quality of a holographic image compared to filters that do not perform such noise filtering. The aperture 302 is a square of side length ⅓ the length of the filter. The aperture 302 is positioned such that its lower right vertex is about ½ the way along the base of the filter 300. The lower left vertex is positioned ⅓ the length of the filter to the left of the lower right vertex. The aperture 304 is rectangular having side lengths of ⅓ and ⅙ the length of the filter and corresponding to the aperture 212 shown in the filter 210. The combined area of the apertures 302, 304 is ⅙ the total area of the filter 300. As in FIGS. 2A and 2B, FIG. 3 also shows portions of the filter 306, 308, 310, 312 that could alternatively be delimited as apertures to give the same effect as apertures 302, 304 through rotation and/or reflection of the apertures 302, 304. These portions 306, 308, 310, 312 are again indicated by solid lines in the filter 300. In particular, an alternative filter having the same filtering effect as the filter 300 could be formed having combined apertures positioned at 306 and 308, 304 and 310, and 306 and 312.

It will be appreciated that these are just examples of the shapes of apertures that can satisfy the requirement that F(H) does not overlap with at least one other component of its series expansion in the Fourier plane and the disclosure is not limited to any particular form. For example, although all the filters described above have straight sides, which can be useful to maximise useable area, other examples may use curved sides, or may choose not to maximise useable area of the filter.

While the discussion above has considered maximising the area of the aperture such that all the unwanted components are blocked, some examples may use a still larger aperture. In general, the higher order noise components are not evenly distributed within the Fourier plane and will tend to have a lower power and/or amplitude at their periphery than in the centre. The size of the aperture may therefore be increased slightly beyond the ⅙ criterion described above without introducing too much noise. For example, the aperture may have an area of between ⅕ and ⅙ of a unit square in the Fourier plane and still exhibit improved performance with a hologram targeting the aperture, compared to not targeting the hologram and having no aperture.

### Increasing Eyebox Size Using Time Multiplexing

The discussion so far has considered apertures that are static, in that their position within the filters does not change in time. In these examples, the maximum area of the filter delimiting the aperture is ⅙^{th} of the total area. While this has the advantages discussed above in terms of improved image quality, it does mean that the area in which the hologram can be viewed is reduced. The inventors have found that an effective viewable area in which the hologram can be perceived (sometimes referred to as an “eyebox”) can be increased by using a plurality of portions which are selectively controlled to either allow light to pass or to block light from reaching a viewer. The aperture then comprises the portions of the filter that allow light to pass. The portions may be configured to allow at least two of the sets of apertures {202}, {212, 214}, {302, 304} shown in FIGS. 2A, 2B and 3, to be used sequentially. In this way, the position of F(H) within the Fourier plane may be varied over time. Given a suitably fast display, such as a DMD, the display can then rapidly switch between different positions within a single frame period. The viewer will perceive such a series of rapidly displayed holograms as a single hologram, through persistence of vision.

While One Step Phase Retrieval (OSPR) algorithms also exploit the persistence of vision, the methods of the present disclosure can give higher quality results with lower use of computational resources. In OSPR, many holograms using the entire Fourier plane, but with different random phase patterns, are displayed in rapid temporal succession and the viewer's eye combines them to perceive a single hologram with overall reduced noise (the noise averages out). The concept here uses the same persistence of vision effect, but rather than average out the effect of noise, the averaging is used to increase the portion of the Fourier plane which is used and thus the viewable area. Furthermore, rather than calculate multiple holograms with different random phase patterns, as in OSPR, the method here can simply mask a hologram with the same random phase pattern, which is computationally less intensive. Nevertheless, other examples may use different random phase patterns for each displayed hologram, effectively applying the apertures disclosed herein to OSPR.

Some examples may combine OSPR with the aperture described herein. In that case the OSPR may make use of a lower bit depth because of the noise reduction provided by the aperture. The OSPR becomes less computationally intensive and/or can process frames more quickly to maximise the benefit of the time-averaging effect to reduce noise in OSPR.

The portions can be arranged contiguously within each unit cell of the filter, i.e. the portion of the filter with dimensions λf/p, so that multiple portions exist per unit cell. The SLM may then be configured to generate the holographic light field, H, so that F(H) is targeted at one or more portions of the filter activated to be transmissive. Synchronising the activated portions of the filter with the holographic light field generated by the SLM targeting those portions allows an increase in the effective area of the hologram generated at a target plane. If the portions of the filter are activated and deactivated at sufficient speed, such as greater than or equal to 100 Hz, 200 Hz or more, a viewer may not perceive the switches. This allows a further effective increase in the size of the eyebox.

The size of eyebox achievable by the display can be increased by providing a filter comprising a set of apertures, the set of apertures comprising a plurality of subsets of apertures, and each subset comprising at least one aperture, wherein the union of the set of apertures forms a shape which is simply connected, or bounded by a simple closed curve. A simple closed curve is a closed curve without intersections. It is understood that “curve” is construed in the broadest mathematical sense of the term and can include any combination of straight lines, curved edges and vertices. A shape is simply connected if any simple closed curve can be shrunk to a point continuously in the shape. A simply connected shape may be said to be space-filling. Such a shape may also be described as lacking self-intersections of the perimeter or holes in the interior of the shape. The union of apertures forming a simply connected shape allows more of an image plane to be targeted, and thus the size of the eyebox of a display system to be increased. The simply connected criterion also improves tessellation of the set of apertures. The union of apertures in the Fourier plane is essentially the exit pupil of an image generating unit of a display system incorporating the spatial filter. Therefore, the enlarged and simply connected region covered by the union of the apertures corresponds to an enlarged exit pupil in real/physical space.

A subset of apertures in this respect is understood to correspond to one or more apertures that correspond to a single F(H), so an example of a subset of apertures would be the apertures 212 and 214. A set of apertures compliant with this simply connected criterion cannot be achieved when all of the subsets of apertures correspond to an F(H) which does not overlap with all of the noise terms up to second order. Instead, to comply with the simply connected criterion, at least one of the subsets of apertures may satisfy the weaker non-overlapping condition wherein the corresponding F(H) does not overlap F(H*), but does have some overlap of the second order F(H²), F(H*²) and F(HH*) terms. Such a combination of subsets of apertures can still provide improved image quality over a filter that is arranged not to block any of the noise components, while providing a potential large increase in the eyebox size. An example of apertures that fulfil this weaker non-overlapping condition are shown in the filter 300 of FIG. 3.

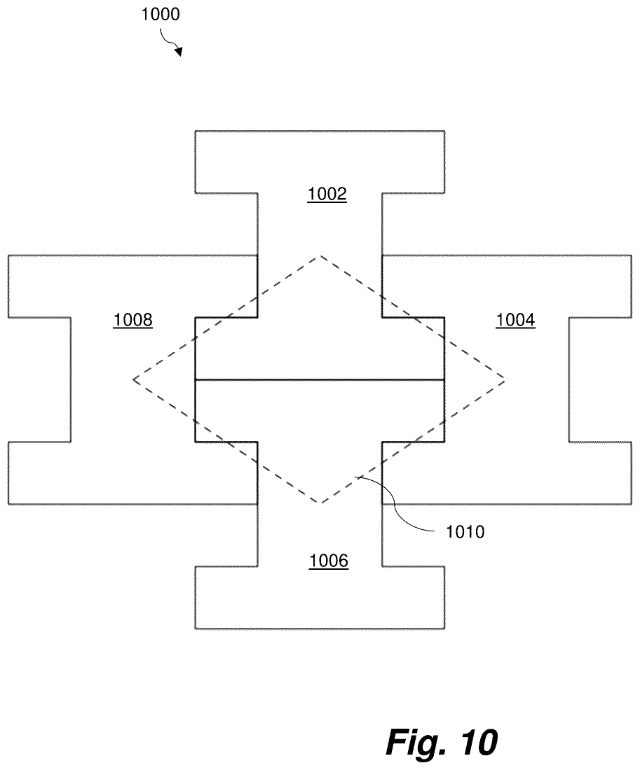

The shape formed by the union of the set of apertures may be a simple polygon. The upshot of this is that the shape can be selected such that it can be substantially tessellated. The shape may periodically tessellate to a two-dimensional plane, such as in the example shown in FIG. 10 discussed below. Tessellation is particularly useful in expanding the size of an achievable eyebox in a holographic display system because a filter may be provided that delimits a plurality of sets of apertures, the union of the set of apertures forming the tessellating shape, and so each set of apertures essentially forms a tessellation of the Fourier plane. That is, a filter can be provided such that any region of the Fourier plane can be targeted in a space-filling manner. As will be further discussed below, another advantage of having the union of the set of apertures form a shape that tessellates is that when used with an image replicating combiner, the image replicating combiner can replicate the shape to provide continuous coverage over an expanded phase volume, thereby increasing the coverage of the addressable eyebox.

### Improving Coverage of the Fourier Plane

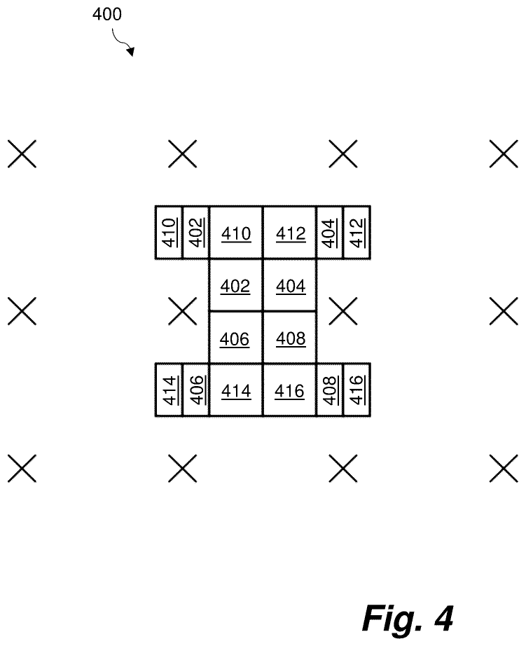

From equation 2 above, the quantised hologram in the Fourier plane includes a delta function (sometimes referred to as the zero order). This is a diffraction peak and is not desirable to retain, so is ideally blocked by the spatial filter. FIG. 4 shows an example of a filter 400 in which a union of the apertures is formed so that a simply connected shape is provided which does not coincide with integer diffraction peaks, so that constants due to quantisation noise are filtered. More specifically, the spatial filter 400 comprises a plurality of portions 402 to 416, corresponding to areas which can be controlled to allow light to pass or not. The portions of the filter 400 correspond to similar apertures to those illustrated in FIGS. 2B and 3, with rotations and reflections included. More specifically portions 410, 412, 414 and 416 each comprise two apertures in the form of apertures 212 and 214 in FIG. 2B, while portions 402, 404, 406 and 408 each comprise two apertures in the form of apertures 302 and 304 as shown in FIG. 3. In this example, each of the portions 402 to 416 of the filter 400 satisfy the maximal area condition for the case where F(H) does not overlap with any of the noise terms up to second order. This means that each of the portions 410 to 416 that satisfy the stronger non-overlapping condition maximise the amount of light transmitted by the spatial filter and each of the portions 402 to 416 allow the same amount of light to be transmitted.

The “X”s indicate locations of a diffraction peak for light of a given wavelength, so that it is understood that the filter 400 delimiting the portions 402 to 416 extends beyond a single unit square defined by successive horizontal and vertical diffraction orders. In fact, the filter 400 extends over 6 unit squares covering four horizontal diffraction orders and three vertical diffraction orders. As described above, the filter 400 may be positioned in the Fourier plane such that the centre of the union of the portions substantially aligns with a peak diffraction efficiency of the modulator being used to display H. In the example of FIG. 4, the maximum diffraction efficiency is not coincident with a diffraction peak, but is aligned vertically as shown with the central row of diffraction peaks and positioned at a mid-point horizontally between the central two columns of diffraction peaks shown. As can be seen from FIG. 4, the diffraction peaks themselves are outside all the apertures, helping to filter zero order components arising from quantisation. More generally, it can be appreciated that a filter with a union of apertures defining a substantially “I” or “H” shape can be positioned on a Fourier plane such that no aperture includes a diffraction peak, or at least so that it substantially does not include a diffraction peak.

At any one time, a single one of the portions 402 to 416 is in a state to allow light to pass, while all other portions are in a state where light does not pass. Correspondingly, a holographic light field, H, may be targeted so that F(H) corresponds to the portion that allows light to pass. In use, a controller may supply a suitable hologram to the SLM and control the filter 400 so the relevant portion allows light to pass. Some SLMs may be operated quickly enough that all eight portions 402 to 416 can be displayed in a single frame period. Any sequence of operation can be used, including incrementing from portions 402 to 416 as labelled and decrementing from portions 416 to 402 as labelled.

The union of all of the portions 402 to 416 forms an irregular dodecagon that substantially takes the form of an “I”. It is understood using the rules of reflection and translation that an equivalent spatial filter can be produced by providing the portions 402 to 416 rotated 90 degrees in the plane. In this case, the union of the portions 402 to 416 forms an irregular dodecagon that substantially takes the form of an “H”.

The total area covered by the union of the portions 402 to 416 is 4/3 of the area of a grid square defined by neighbouring diffraction orders. Therefore, the filter 400 can address a larger phase volume than would be possible for a typical CGH display with a fixed aperture.

The controllable portions of FIG. 4 can be manufactured in a variety of ways. For example, the filter 400 could be manufactured of liquid crystal and operated to either substantially allow light to pass or substantially block light. The liquid crystal may have a high switching speed such as pi-cell or Ferroelectric LCD (FLCD). Other examples may use a DMD as the filter, where the DMD is controlled not to modulate the light field but to control what parts of the modulated light are allowed to pass through. Another example may use a rotating chopper wheel, with the chopper wheel rotating to define each of the plurality of apertures and the laser synchronised to the chopper wheel. The chopper wheel may use a stepper motor or similar to control rotational position, for example. Of course, the filter 400 could utilise any suitable shutter technology, examples of which include Molecular-based, Quantum Optical and Plasmonic Metamaterials shutters.

In the previous discussion of FIGS. 2A to 4, F(H) has been discussed as being generated by light of a single illumination wavelength. However, the principles described herein can be extended to cover light of a plurality of illumination wavelengths. Such light could be generated by a plurality of light sources, such as a plurality of single mode lasers, or a single light source operating at a plurality of wavelengths. In the case of multiple illumination wavelengths, the aperture(s) may be selected so that the condition of no overlap of F(H) with the noise components is exact for light of a first wavelength, but only approximate for light of a second wavelength. This allows for approximate full-complex modulation of multicolour holograms.

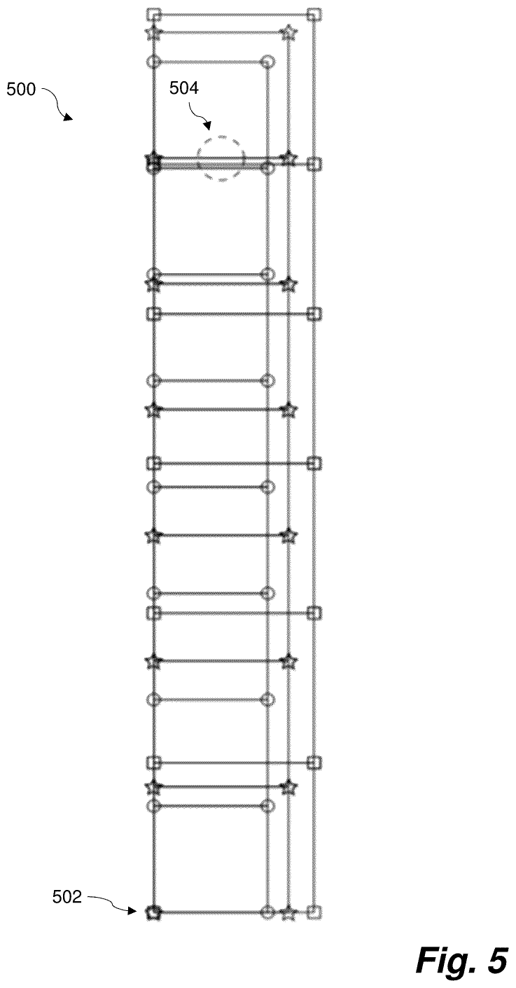

FIG. 5 shows an example of the horizontal and vertical diffraction orders 500 for three wavelengths of light, 450 nm (blue light), 520 nm (green light) and 635 nm (red light) generated using an example DMD, in this case, a DLP670S commercially available from Texas Instruments. Diffraction orders of the blue light are indicated with circles, diffraction orders of the green light are indicated with stars, and diffraction orders of the red light are indicated with squares. As can be seen from the Figure, the zeroth diffraction orders of each of the three wavelengths coincide at the same point 502. However, the position of every other diffraction order varies with wavelength. As has been described above, a DMD behaves like a blazed grating so that the peak diffraction efficiency is offset from the zeroth diffraction order. In the example shown in FIG. 5, the position in the Fourier plane for which diffraction efficiency is maximised is shown by the dotted circle 504. The peak diffraction efficiency will normally be at a fixed angle determined by the angle of the mirrors of the DMD in their ‘on’ state, and independent of wavelength, whereas the angle of a given diffraction order does depend on wavelength, so exactly where this peak sits relative to the integer orders is dependent on the wavelength. It is possible to choose the wavelengths of light such that the peak diffraction efficiency is approximately aligned with an integer vertical order. In this case, the three wavelengths are selected so that the peak diffraction efficiency approximately aligns with the 5th, 6th and 7th vertical orders for the red, green and blue light respectively. The peak diffraction efficiency also occurs halfway between the 0th and 1st diffraction orders for each wavelength horizontally.

FIG. 6 shows a photograph 600 corresponding to a real life demonstration of the example illustrated in FIG. 5, showing the peak diffraction efficiency of an example DMD approximately aligning with the 5th, 6th and 7th vertical orders for red, green and blue light respectively, and halfway between the 0th and 1st diffraction orders for each wavelength horizontally. When a DMD is used as the SLM, it may therefore be advantageous to align the plurality of apertures with the peak diffraction efficiency to increase the amount of light that can be transmitted by the filter.

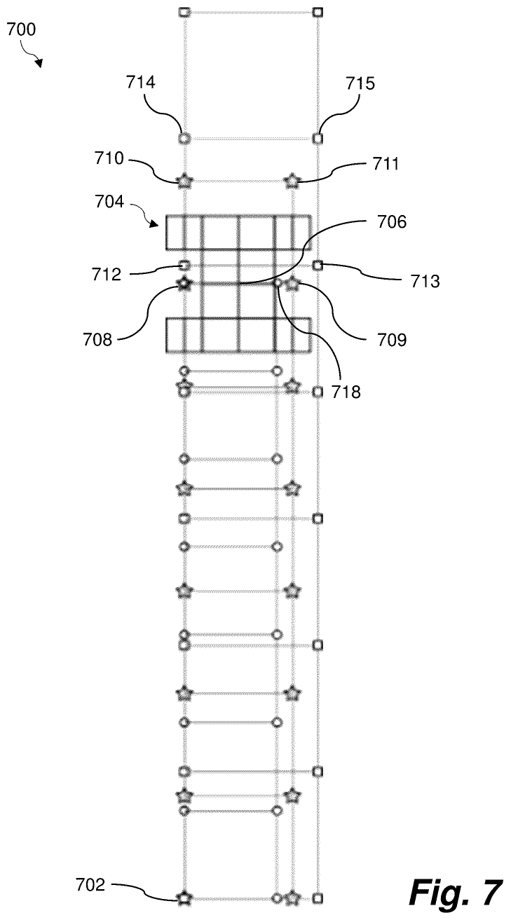

FIG. 7 shows an example of the horizontal and vertical diffraction orders 700 for three wavelengths of light, as shown in FIG. 5, and how an example filter 704 may be positioned such that the union of apertures are aligned with the peak diffraction efficiency of an example DMD, in this case the DLP670S, commercially available from Texas Instruments in a landscape orientation. Filter 704 has the same configuration of apertures as filter 400. The horizontal and vertical diffraction orders are represented as in FIG. 5, with the diffraction orders of the blue light indicated with circles, diffraction orders of the green light indicated with stars, diffraction orders of the red light indicated with squares, and the zeroth diffraction orders of each of the three wavelengths coinciding at the same point 702. In this case, the three wavelengths of light are 442.8 nm (blue light), 515.8 nm (green light) and 637.8 nm (red light), and the DMD device is a DLP670S. This selection causes the peak diffraction efficiency to approximately align with the 5th, 6th and 7th vertical orders for the red, green and blue light respectively. The example filter 704 is a good option for use with the example DMD and wavelengths because the geometric centre 706 of the shape formed by the union of the apertures can be positioned halfway between horizontal diffraction orders. The position of the filter 704 as shown, is such that the central diffraction peaks 708 and 709 align with the two central “X”s shown in FIG. 4 and correspond to the 6^{th} vertical and 0^{th} and 1^{st} horizontal diffraction orders for green light. This arrangement is particularly efficient because the geometric centre of the union of apertures is aligned with the maximum diffraction efficiency of the DMD.

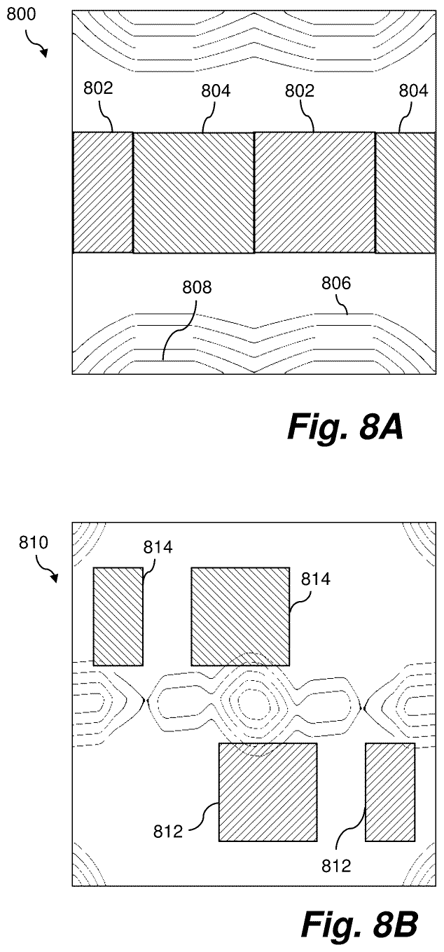

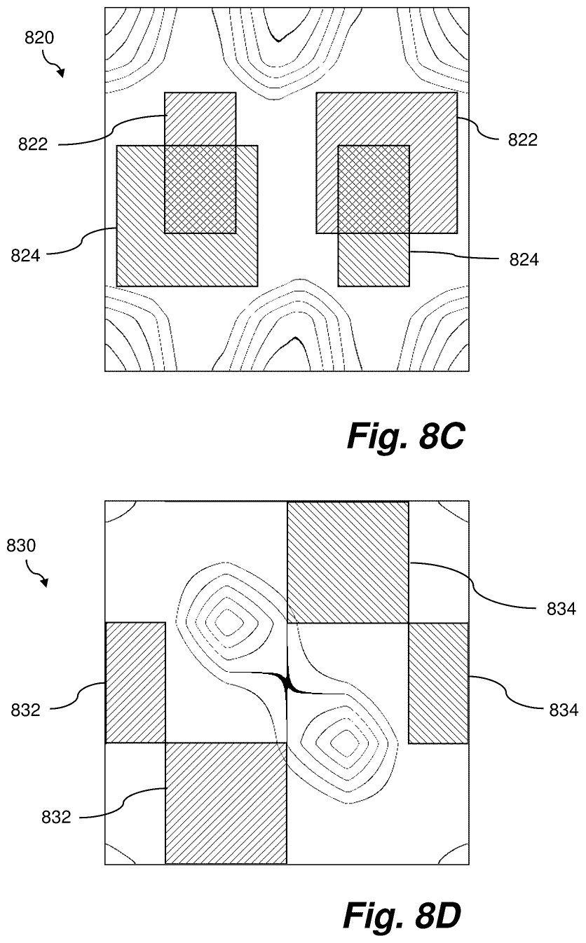

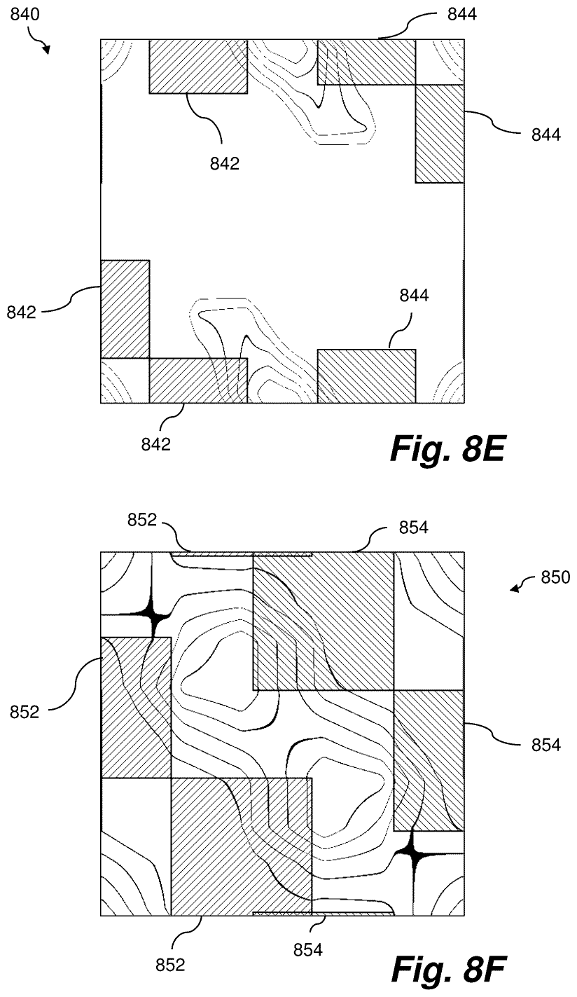

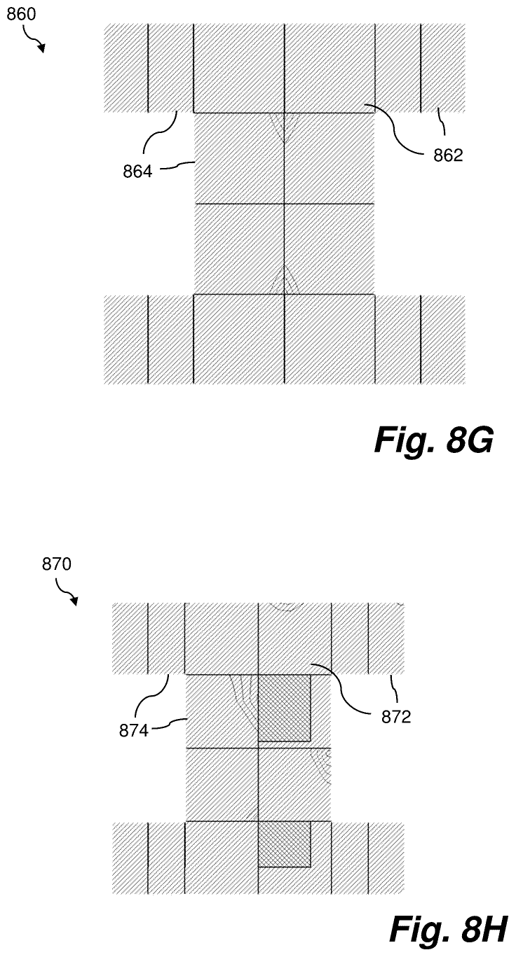

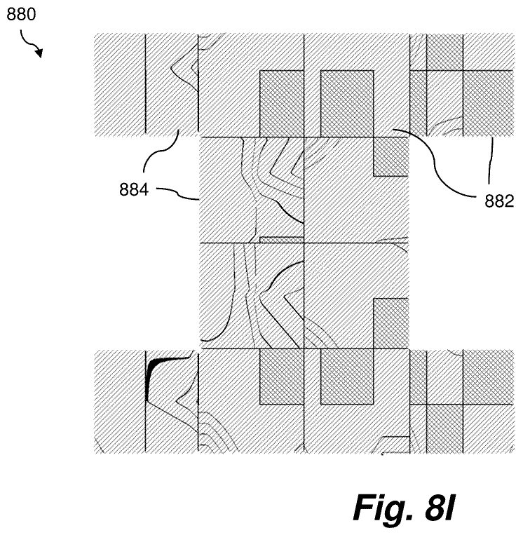

FIGS. 8A to 8I show examples of the positions of F(H), represented by diagonal hatched lines pointing towards the top right, and F(H*), represented by diagonal hatched lines pointing towards the top left, for some of the subsets of apertures of the filter 400 for green, red and blue light. As previously mentioned, because the target light field, H, is sampled on a grid of pixels, the fields in the Fourier plane repeat continuously over the plane. FIGS. 8A to 8I each define a unit cell of a 2d periodic pattern repeating over the Fourier plane, and each is associated with a particular subset of apertures from FIG. 4 and a particular wavelength. In FIGS. 8A to 8I, the position of F(H) is selected so that when F(H) is repeated over the plane, every point in the particular subset of apertures coincides with a point in the resulting 2d periodic F(H), and each point on the F(H) shown coincides with a point on the particular subset of apertures in exactly one repetition of F(H) across the Fourier plane. Because of this, the shapes of the subsets of apertures appear to be wrapped around in some of the FIGS. 8A to 8I. The apertures are positioned to be aligned with the peak diffraction efficiency of an example DMD as shown in FIG. 7, and have been selected to satisfy the above defined non-overlapping conditions for green light. In FIGS. 8A to 8I, the higher energy/amplitude values generated from higher order terms F(HH*), F(H²) and F(H*²) are also shown, represented by contour lines marking the boundaries of the 50th, 60th, 70th, 80th and 90th percentiles of energy values from these higher orders. This is because these higher order terms also contain reasonable amounts of energy, so it may be useful to select the apertures such that some subsets of apertures satisfy a further condition that F(H) does not substantially overlap with F(HH*), F(H²) and F(H*²).

FIGS. 8A to 8F were each generated such that the corners correspond with diffraction orders in FIG. 7, and in each case those orders form one square on the grid of orders for the respective wavelength. As previously mentioned, because the target light field, H, is sampled on a grid of pixels, the fields in the Fourier plane repeat on a grid of the squares forming a repeating pattern of the components F(H), F(H*), F(HH*), F(H²) and F(H*²). The F(H) component in each of FIGS. 8A to 8F corresponds to a physical aperture from the filter in FIG. 4 but the shape of the physical aperture sometimes appears “wrapped around” in the figures as a consequence of this representation of the physical aperture in relation to the periodic fields F(H), F(H*) etc.

FIG. 8A shows an example 800 of where F(H) 802 and F(H*) 804 for green light are to be displayed on a filter delimiting the apertures 212, 214 in FIG. 2B and apertures 412 in FIG. 4. The correspondence of F(H) 802 and apertures 412 can be visualised by taking the left half of FIG. 8A and placing it adjacent to the right half of FIG. 8A. As previously discussed, this is because components on the Fourier plane repeat in a periodic pattern. As can be seen, F(H) and F(H*) form a pattern as expected from the discussion above with regards to FIGS. 1A to 1G, and there is no overlap between the two. It may further be seen that both the 50th percentile 806 and 90th percentile 808 of energy values generated by higher orders terms F(HH*), F(H²) and F(H*²) are at a substantial distance from F(H). If these contour lines were to be continued to the lower percentiles, it would be seen that the higher order terms F(HH*), F(H²) and F(H*²) do not substantially overlap with F(H) in FIG. 8A. The extent of FIG. 8A represents a unit cell of all the components F(H) etc. that repeat across the Fourier plane. The repetition in which the left most aperture of 412 (the square) in FIG. 4 coincides with F(H) 802 in FIG. 8A, is also the repetition in which the bottom left corner of FIG. 8A coincides with the diffraction order 708 in FIG. 7. Likewise, the repetition in the right-most aperture of 412 in FIG. 4 coincides with F(H) 802 in FIG. 8A, is also the repetition in which the bottom left corner of FIG. 8A coincides with the diffraction order 709 in FIG. 7.

FIG. 8B shows an example 810 of the relative positions of F(H) 812 and F(H*) 814 for red light incident on an SLM in the configuration used to generate the fields as in FIG. 8A (i.e. where F(H) 812 is displayed on apertures 412 in FIG. 4). The region 810 shown in FIG. 8B may correspond to the region defined by 712, 713, 715 and 714 in FIG. 7. As explained above, the different colour of the source means that the longer wavelength causes the fields to repeat over different distances. For red light, it may be seen that there is no overlap of F(H) 812 and F(H*) 814. There is some overlap between F(H) 812 and the higher order terms, however the energy values above the 70th, 80th and 90th percentiles range do not overlap and may therefore be blocked.

FIG. 8C shows an example 820 of F(H) 822 and F(H*) 824 for blue light if it were incident on an SLM in the configuration used to generate the fields in FIG. 8A. The repetition in which the left most aperture of 412 (the square) in FIG. 4 coincides with F(H) 822 in FIG. 8C, is also the repetition in which the bottom right corner of FIG. 8C coincides with the diffraction order 718 in FIG. 7. Likewise, the repetition in the right-most aperture of 412 in FIG. 4 coincides with F(H) 822 in FIG. 8C, is also the repetition in which the bottom left corner of FIG. 8C coincides with the diffraction order 718 in FIG. 7. In this case, there is overlap of F(H) 822 and F(H*) 824, which can reduce the image quality for an image displayed using blue light. However, such a reduction in quality in this subset of apertures is acceptable when used as part of a larger filter delimiting a set of apertures as in the filter 400. For the higher order terms, it is worth noting that the energy values above the 50th percentile range do not overlap with F(H) 822 and may therefore be blocked.

FIG. 8D shows an example 830 of where F(H) 832 and F(H*) 834 for green light are displayed corresponding to the apertures 302, 304 in FIG. 3 and apertures 402 in FIG. 4. The region 830 shown in FIG. 8D may correspond to the region defined by 708, 709, 711 and 710 in FIG. 7. As can be seen, F(H) 832 and F(H*) 834 form a pattern as expected from the discussion with regards to FIGS. 1A to 1G, and there is no overlap between the two. There is some overlap between F(H) 832 and the higher order terms, however the energy values above the 70th, 80th and 90th percentiles range do not overlap and may therefore be blocked.

FIG. 8E shows an example 840 of F(H) 842 and F(H*) 844 for red light incident on an SLM in the configuration used to generate the fields as in FIG. 8D. It can be seen that the aperture 402 in FIG. 4 spans two repetitions of the unit cell as it is shown in FIG. 8E, so that both the top-left and bottom-left corners of FIG. 8 correspond to diffraction order 712 in FIG. 7. It can be seen that there is no overlap of F(H) 842 and F(H*) 844 for red light. There is more noticeable overlap between F(H) 842 and the higher order terms. However, as the energy in the series expansion tends to be concentrated in lower order terms, ensuring no overlap with at least F(H*) results in acceptable image quality for these colours using this arrangement of apertures.

FIG. 8F shows an example 850 of F(H) 852 and F(H*) 854 for blue light incident on an SLM in the configuration used to generate the fields as in FIG. 8D. Here the edge of a repeated pattern is visible, because the aperture 402 in FIG. 4 spans two repetitions of the unit cell as it is shown in FIG. 8F, so that both the top-right and bottom-right corners of FIG. 8F correspond to diffraction order 718 in FIG. 7. There is some very minor overlap of F(H) 852 and F(H*) 854 for blue light, and there is noticeable overlap between F(H) 852 and the higher order terms. However, such a reduction in quality in this subset of apertures is acceptable when used as part of a larger filter delimiting a set of apertures as in the filter 400.

FIG. 8G shows an example 860 indicating the overlapping contributions of F(H), F(H*), F(HH*), F(H²) and F(H*²) for green light, that pass through all of the apertures of the filter 400 shown in FIG. 4 and with the filter positioned as shown in FIG. 7, with the apertures selected to satisfy the above defined non-overlapping conditions for green light. Apertures 862 correspond to F(H) 802 in FIG. 8A, and apertures 864 correspond to F(H) 832 in FIG. 8D. Unlike in FIGS. 8H and 8I, no overlap of F(H) with F(H*) can be seen. It may further be seen that apertures corresponding to 410, 412, 414 and 416 in FIG. 400 (of which apertures 862 are an example) all satisfy the further conditions of no substantial overlap between F(H) and higher order terms F(HH*), F(H²) and F(H*²) for green light. Apertures corresponding to 402, 404, 406 and 408 (of which apertures 864 are an example) have some small overlap of F(H) with higher order terms, but the first non-overlapping conditions for F(H) and F(H*) are still met.

FIG. 8H shows an example 870 indicating the overlapping contributions of F(H), F(H*), F(HH*), F(H²) and F(H*²), for red light, that pass through all of the apertures of the filter 400 shown in FIG. 4 and with the filter positioned as shown in FIG. 7. Apertures 872 correspond to F(H) 812 in FIG. 8B, and apertures 874 correspond to F(H) 842 in FIG. 8E. As can be seen, there is some overlap of F(H) with F(H*), as well as F(H) with the higher order terms F(HH*), F(H²) and F(H*²), but this remains minimal over the whole of the filter.

FIG. 8I shows an example 880 indicating the overlapping contributions of F(H), F(H*), F(HH*), F(H²) and F(H*²) for blue light, that pass through all of the apertures of the filter 400 shown in FIG. 4 and with the filter positioned as shown in FIG. 7. Apertures 882 correspond to F(H) 822 in FIG. 8C, and apertures 884 correspond to F(H) 852 in FIG. 8F. For blue light, there is more overlap of F(H) with F(H*) than there is for red light, however, it is still a relatively low proportion of the total area so that the overall impact on image quality is deemed sufficiently small. There is also more overlap of F(H) with the higher order terms F(HH*), F(H²) and F(H*²) than for red light, but this condition has less impact on image quality than the overlap of F(H) with F(H*).

FIGS. 8A to 8I illustrate the situation where the same apertures are used for different colours without having a significant impact on the image quality. However, in other examples, separate optics may be provided for each colour. For example, different physical arrangements of the light sources of the different wavelengths may alter the relative positions of the diffractions orders shown in FIG. 7, resulting in different overlaps between F(H), F(H*) and the higher order terms across the union of the sets of apertures for each wavelength. In other examples, a separate set of apertures for each colour may be provided.

Example Display System for Use with Techniques Described Herein

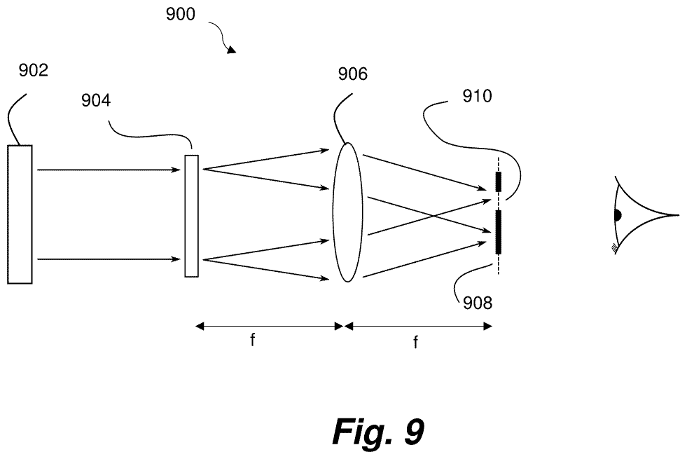

FIG. 9 shows, in general terms, a holographic optical system 900 that can be used with the spatial filters discussed above. The system 900 comprises a light source 902 configured to generate at least partially coherent light. The system 900 further comprises a spatial light modulator (SLM) 904 arranged to be illuminated by the at least partially coherent light. The system 900 further comprises a lens 906. The lens 906 has a focal length, f, and is positioned one focal length from the SLM 904. The system 900 further comprises a filter 908 delimiting a set of apertures switchable between a substantially transmissive and a substantially non-transmissive state, wherein the set of apertures comprises a plurality of subsets of apertures, each subset comprising at least one aperture. The union of the set of apertures forms a shape which is simply connected.

The filter 908 is positioned one focal length from the lens 906, on the opposite side of the lens 906 from the SLM 904. An example of a suitable filter is shown in FIG. 4 with configurations as discussed above.

The SLM 904 is arranged to be illuminated by the at least partially coherent light and to generate a time sequence of light fields, wherein each of the light fields is a quantised representation of a target light field. Each of the time sequence of quantised target light fields corresponds to a respective one of the plurality of subsets of apertures of the filter 908, in substantial synchrony with a respective one of the plurality of subsets of apertures of the filter 908 being in a substantially transmissive state.

The arrangement of the holographic optical system 900 is such that the Fourier transform of the light fields, F(H), is formed at a plane coinciding with the position of the filter 908. This plane is the Fourier plane of the SLM 904 as formed by the lens 906. The target light fields are determined such that the Fourier transform of the target light fields, F(H), do not overlap at least the Fourier transform of the complex conjugate of the corresponding target light field, F(H*), in the Fourier plane of the SLM 904. Further, each subset of apertures in the filter 908 corresponds to an F(H) in the Fourier plane, such that portions of the target light fields outside of F(H) are blocked.

The light source 902 may, for example, comprise a laser module or an LED. The light source 902 is configured to generate at least partially coherent light at one wavelength, or a plurality of wavelengths (corresponding to red, green and blue, for example).

The SLM 904 may be configured to modulate at least one of the phase, amplitude, binary phase and binary amplitude of the light. The SLM 904 may be, for example, a DMD, an LCD, an amplitude LCoS or a phase LCoS.

The display system 900 may comprise a controller configured to cause the SLM 904 to display the time sequence of quantised target light fields.

As shown, the SLM 904, lens 906 and filter 908 are coaxial. Other configurations may also be used, such as a folded light path that may allow a more compact display.

FIG. 9 depicts a transmissive SLM, it will be understood that the principles discussed here are not limited to this and can equally be applied to reflective SLMs. Likewise, the same principles apply to other types of modulator than a SLM.

### Increasing Eyebox Size Using an Image-Replicating Combiner

FIG. 10 shows how the shape formed by the union of the portions 402 to 416 of the filter 400 can be tessellated. In particular, the union of the portions 402 to 416 can be tessellated on a rhombic grid. A portion of the rhombic grid is indicated by the dotted line 1010 which has the form of a rhombus and whose vertices coincide with the geometric centre of a respective shape 1002, 1004, 1006, 1008. This arrangement of the union of portions 402 to 416 provides a particular advantage when the holographic light field is transmitted via an image replicating combiner that is configured to generate replications of the light field on a rhombic grid because the image replicating combiner can replicate the shape to provide near-continuous coverage over an expanded phase volume, thereby increasing the coverage of the addressable eyebox of the display system.

Image-replicating combiners can be used to increase the addressable size of the eyebox of a display system. When the holographic optical system 900 further comprises an image replicating combiner, positioned in an optical path after the filter 908, the larger addressable eyebox can be coupled with the properties of the filter 908 to increase the eyebox coverage.

In general, image-replicating combiners comprise an input surface, also known as an in-coupler or an entrance pupil, to receive light rays corresponding to an input image. The notion of an entrance pupil corresponds to the limiting aperture in an input of the image-replicating combiner. The input surface is a coupling feature that couples light waves, propagating externally, to the inside of the image-replicating combiner. The coupling feature may be, for example, an array of mirrors, an array of prisms, a diffraction grating or a hologram. Further possible coupling features include embedded mirrors, micro-prisms, a surface relief slanted grating, a surface relief blazed grating, a surface relief binary grating, a multilevel surface relief grating, a thin volume hologram, a thin photopolymer hologram, a Holographic Polymer Dispersed Liquid Crystal (H-PDLC) volume holographic coupler, a thick photopolymer hologram, a resonant waveguide grating, a metasurface coupler and embedded half-tone mirrors. An image-replicating combiner further comprises an output surface, also called an out-coupler, to output light corresponding to the input image. The output surface is a further coupling feature, which may use the same technology as the input surface. Image-replicating combiners may be manufactured from materials with high-refractive indices that support total internal reflection over a wide range of internal incidence angles. Lanthanum dense flint glass, for example N-LASF46 manufactured by Schott™, has a critical angle of θ_{c}=310 at wavelength λ=530 nm. An image-replicating combiner will propagate waves by total internal reflection at all internal angles above the critical angle.

In an example, an image-replicating combiner takes the form of a substantially planar sheet. The planar sheet may be constructed from a transparent material, such as glass. In this case, one arrangement for the input and output surfaces is to position them on the same side of the planar sheet, such that light enters and exits at the same side of the planar sheet. In another arrangement, the input and output surfaces may be positioned on opposite sides of the planar sheet. The particular arrangement may be selected based on a function of the image-replicating combiner. In other examples, a combiner takes the form of a non-planar sheet. Such combiners may find use as a lens in a pair of spectacles, for example. In non-planar combiners, the input and output surfaces of the combiner may be on the same or opposite sides of the sheet depending on the function of the combiner, as described above.

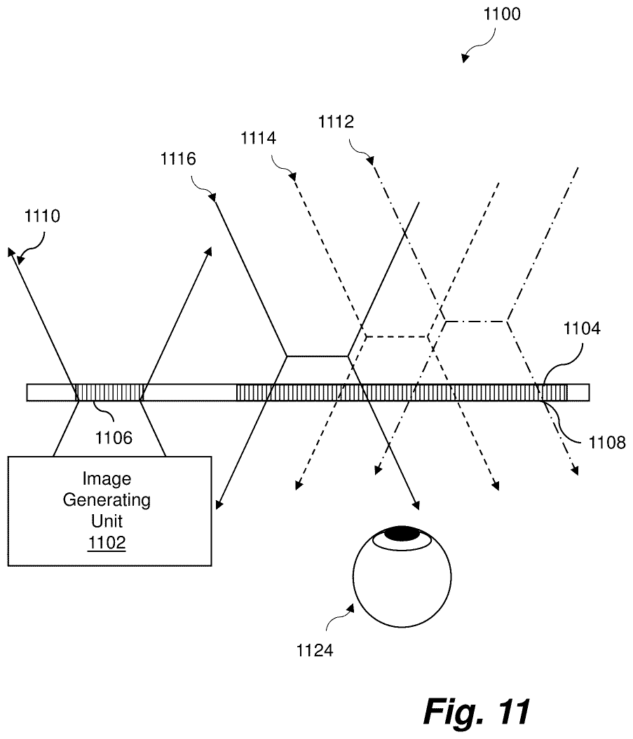

FIG. 11 is a schematic diagram of a display system 1100 with an image generating unit 1102 and an image-replicating combiner 1104 to show the properties of such a system. The image generating unit 1102 is configured to generate an input light field 1110. The image-replicating combiner 1104 comprises an input surface 1106 and an output surface 1108. Multiple replications of the input light field 1110 are generated at the output surface 1108. In FIG. 11, three replications 1112, 1114, 1116 are shown, each corresponding to light that has undergone different numbers of internal reflections within the image-replicating combiner 1104.

PCT patent application publication no. WO2023/057543, having priority date 6 Oct. 2021, which is hereby incorporated by reference for all purposes, describes a method of displaying a target light field using an image-replicating combiner. The method comprises determining a target light field to be displayed at a viewing location; determining a transfer function describing the propagation of light through the image-replicating combiner between the viewing location and an input location near to an input surface of the image-replicating combiner; determining an input light field by applying the determined transfer function to the target light field; and displaying the input light field at the input location. Using this method, it is possible to generate a desired light field at a desired location.

When combining the features of the systems shown in FIGS. 9 and 11—that is to say, when the holographic optical system 900 further comprises an image replicating combiner, positioned in an optical path after the filter 908—the filter 908 may act as the exit pupil of the image generating unit 1102. In this construction then, the image replicating combiner 1104 generates multiple replications of an input light field that is determined by the union of the sets of apertures delimiting the spatial filter. Having a union of the set of apertures that form a shape that substantially tessellates is therefore particularly advantageous when used with an image replicating combiner, because the image replicating combiner can replicate the shape to provide near-continuous coverage over an expanded phase volume, thereby increasing the coverage of the addressable eyebox.

A feature of image-replicating combiners is that internal rays repeatedly split into reflected and transmitted rays. The etendue of the output ray ensemble is larger than that of the input ensemble. In terms of phase space, the phase volume of possible output ray positions and angles is larger than the phase volume of possible input ray positions and momenta. Typically, the maximum valid eyebox and field of view (or more specifically the phase volume) of an output light field after propagation through a typical, planar, image-replicating combiner, are no larger than the pupil and field of view (or more specifically the phase volume) of the input light field, respectively. The term “valid eyebox” here refers to an eyebox substantially without noise and/or artefacts. Typically, the phase space is 4-dimensional and comprises the two spatial dimensions and two angular dimensions. A phase space representation labels each ray through a given plane with spatial coordinates (representing the point it intersects the plane), and angular coordinates (representing the direction in which it is heading relative to the plane). A light field describes the intensity of each point in this phase space. The input light field spans some volume in phase space (a ‘phase volume’), with the output light field spanning a larger phase volume than the input due to the replication process. PCT patent application publication no. WO2023/057543 then describes that a target light field can be generated whose volume in phase space is no larger than the first volume, and which can be targeted anywhere within the second volume.

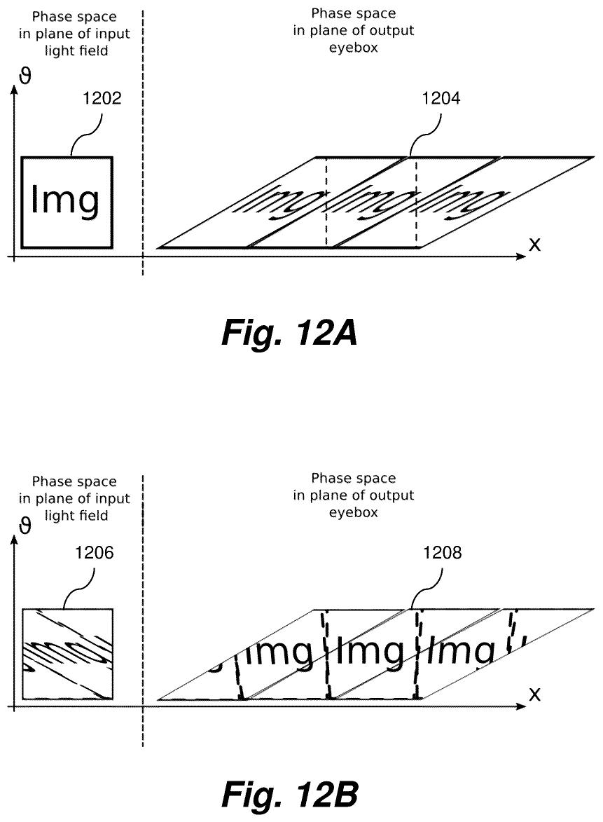

FIG. 12A provides a schematic view of a phase space of a light field 1202 incident on the input surface of an image-replicating combiner in a typical display system, and the phase space of the resulting light field 1204 exiting the output surface (i.e. the output eyebox). FIG. 12A shows a 2D light field with a single spatial and angular dimension, but it can easily be seen how the concept extends to further dimensions, such as a 4D light field, with 2 spatial and 2 angular dimensions. FIG. 12A may be thought of as a 2D cross section of a 4D light field.

The action of the image-replicating combiner represented in FIG. 12A is to produce multiple copies of an input light field, spatially separated in the x dimension. Additionally, the replications of the input light field are offset in the z direction from the plane of the output eyebox. Furthermore, the different replications are offset in the z direction with respect to one another. This description of a basic image-replicating combiner is shown diagrammatically in FIG. 11.

In the phase space representation, the offset in z corresponds to a shear in the (x, θ) plane, and so the replicated light fields at the output of FIG. 12A can be seen to be sheared in this way. As the replications are also offset from one another in the z direction, the degree of shear is shown to be slightly different for each replication. The size of the phase volumes of the individual output replications are equal to the size of the phase volume of the input light field. The image-replicating combiner may have a replication pitch chosen to minimise overlaps and gaps between the replicated images.

FIG. 12B provides a schematic view of a phase space of a pre-distorted input light field 1206, incident on a replicating combiner input surface. The pre-distorted input light field 1206 may be calculated according to methods described in WO2023/057543, referenced above. In particular, the pre-distortion may be chosen so that the target light field is correctly displayed in a subset of the phase volume of the output eyebox 1208. The input light field may be generated by applying a transfer function to the target light field at the chosen position within the output eyebox. Such a transfer function describes the propagation of light through the image-replicating combiner between the target light field location and an input location near to an input surface of the image-replicating combiner. The transfer function can be determined in any suitable way. In some examples, the transfer function may be calculated or otherwise determined using analytical and/or numerical methods based on knowledge of the properties of the image-replicating combiner, the viewing location and the input location.

The above descriptions referencing FIGS. 12A and 12B describe the transformation of a 1D replication waveguide on a 2D phase volume for simplicity. However, it is understood that the concepts are straightforwardly transferable to a 2D replicating waveguide and a 4D phase volume. Additionally the concept of a 4D phase volume can be applied to a holographic image as well as a 4D light field, by replacing the concept of ray direction and ray position with the concept of a range of spatial frequencies within a localized region (for example, by replacing each ray with a gaussian beam having the same pointing direction and position as the ray, and expanding a hologram in the basis defined by this set of gaussian beams).

In further examples, the display system 900 may further comprise eye-tracking sensors. The eye-tracking sensors may generate live data about the current location of a viewer's pupil and relay this to a computing device. The computing device may then determine where the target light field is required to be generated such that the resulting light field at the image plane is at the current location of the centre of the viewer's pupil. In practice, the viewer may move their eyes based on a number of factors such as a change in position of an object of interest in the image that is currently being displayed, a change in brightness of the displayed image, and movement of the user themselves as they are viewing the image.

The geometry of how discrete replications appear in phase space is a property of the image replicating combiner. In order to be generally compliant with the tessellating condition described above it is clear that the image replicating combiner should be designed to provide optimal tiling of the replicated outputs in phase space. Specifically, it should be designed such that 1) A high fraction of the volume in phase space required for a target output phase volume is spanned by the combined phase volumes of the discrete replications; and 2) A low fraction of the volume in phase space required for a target output phase volume is covered by more than one overlapping discrete replication. In some examples, the combiner should be designed such that the combined phase volumes of the discrete replications span as much as 75%, 80%, 90%, 95%, and 99% of the volume in phase space required for a target output phase volume. However, a sufficiently high fraction depends on the characteristics of the light field and the pupil size of the user. In certain cases, an acceptable fraction could be as low as 5% (e.g. for a sparsely-sampled light field and highly dilated pupil). The volume in phase space covered by more than one overlapping discrete replication may be between 50-10% of the target output phase volume and could be as low as 5%, 1%, or even 0% of the target output phase volume.

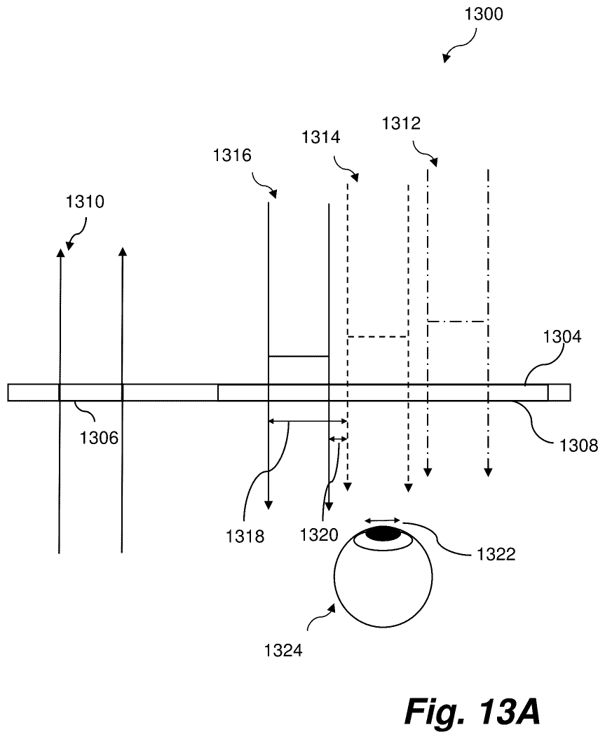

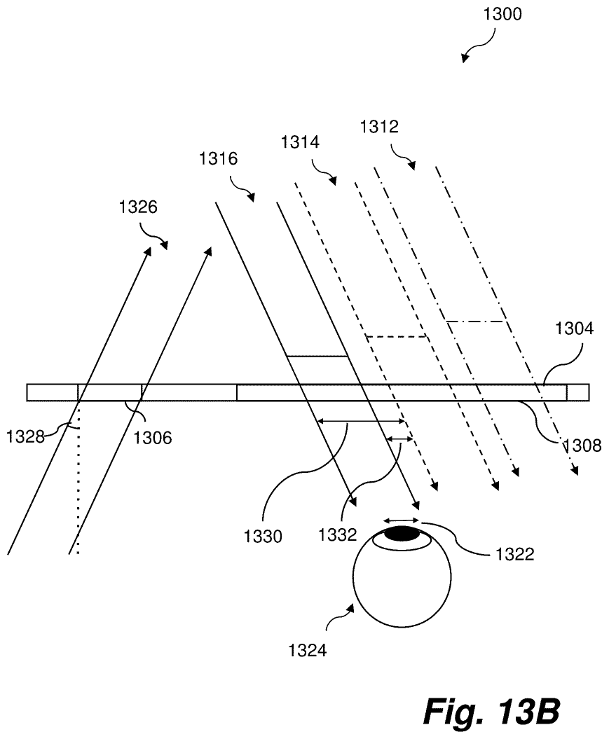

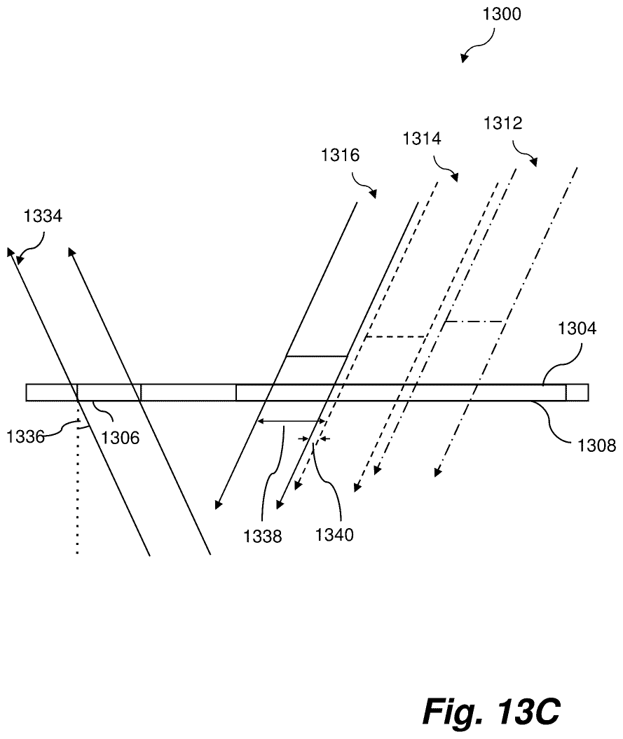

FIGS. 13A, 13B, and 13C will now be used to discuss the way in which the geometry of an image replicating combiner is considered in terms of compliance with the above condition. Although FIGS. 13A, 13B, and 13C show replication along one axis, it may be easily seen how this concept may be extended to replication in 2 directions.

The ideal situation is described above, where the majority of the target phase volume is spanned with minimal overlap. However, it may not be possible or efficient to produce an input light field with a sufficiently large phase volume, nor to produce an image-replicating combiner that does not have gaps between replications, so the preferred design may need to consider these practical limitations.

Referring to FIG. 13A, an input light field 1310, consisting only of rays travelling in the direction of normal incidence, is shown. This input light field is replicated multiple times, shown as 1312, 1314, 1316. Multiple replications of a single ray will be extracted from an image replicating combiner 1304 at an output surface 1308 at a certain spacing, 1318, which is referred to as the replication pitch. Where the width of the limiting aperture 1306 is smaller than the replication pitch 1318, there will be a gap between replications, 1320, where no rays are present for this angle of incidence.

The replication pitch 1318, and hence also the gap between replications 1320, is a function of the angle at which light enters the image replicating combiner 1304. In this picture of one-dimensional replication, perfect tessellation of the input light field requires that the gap between replications is zero. Correspondingly, a two-dimensional input light field may only be perfectly tessellated by two-dimensional image replicating combiner (with two axes of replication) for a single direction of input light rays or viewing angle. Referring to FIG. 13B, for an input light field 1326, consisting only of rays at an incident angle indicated by 1328, the replication pitch 1330 will be maximised, resulting in a maximum gap between replications shown as 1332.

Referring to FIG. 13C, for a different input light field 1334 consisting only of rays at an incident angle indicated by 1336, the replication pitch 1338 will be minimised, resulting in a minimum gap between replications shown as 1340. Substantial tessellation of the replications may therefore only be achieved at a particular viewing angle, corresponding to the incident angle 1336. However, it can be seen that such an image replicating combiner 1304 generates approximately tessellating replications, even when the gap between replications is at a maximum as shown in FIG. 13B.

As discussed above, the design of a 2D image replicating combiner might be such that the replicated phase volumes tessellate on a non-rectilinear grid. For example, an image replicating combiner whose replicated phase volumes tessellate on a rhombic grid would have particular use with the filter 400 shown in FIG. 4. An image replicating combiner that replicates on such a rhombic grid can be achieved by having the two replication axes at an angle other than 90 degrees from one another.

### Example Method of Operation

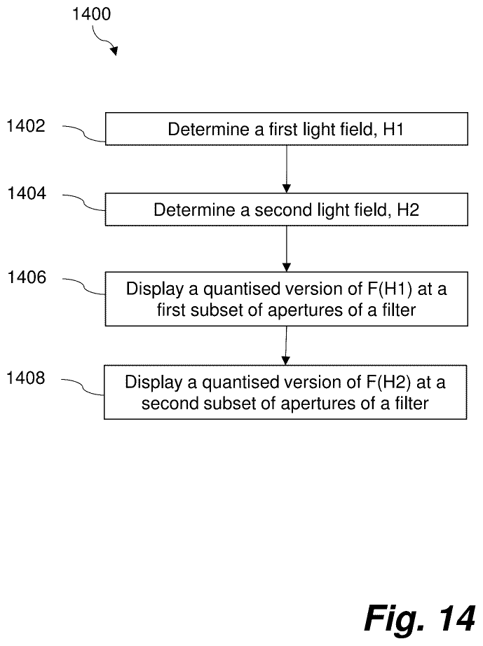

Having explained the theory and overall construction of a holographic display according to the present disclosure, its method of operation will now be explained. FIG. 14 shows a method 1400 of reducing quantisation noise in a holographic image. The method 1400 can be executed by a controller of the holographic optical system 900 shown in FIG. 9, for example. At 1402, the method 1400 comprises determining a first light field, H₁. The first light field has a Fourier transform, F(H₁), with the property that it substantially does not overlap its complex conjugate, F(H₁*). F(H) can be predetermined as occupying a region with these properties, for example as discussed above with reference to FIGS. 2A, 2B and 3.

At 1404, the method 1400 comprises determining a second light field, H₂, for quantisation, the second light field having a Fourier transform, F(H₂), such that it does not substantially overlap a Fourier transform of its complex conjugate, F(H₂*).

At block 1406, and at a first time, the method 1400 comprises displaying a quantised version of the first light field using the holographic display system shown in FIG. 9, wherein a first subset of apertures corresponds to an extent of F(H₁) in a Fourier plane such that components corresponding to F(H*) resulting from quantisation are substantially blocked by the filter. The first subset of apertures is allowing light to pass and the second subset of apertures is preventing (blocking) light from passing.

At block 1408, and at a second time, the method 1400 comprises displaying a quantised version of the second light field using the holographic display system, wherein a second subset of apertures corresponds to an extent of F(H₂) in a Fourier plane such that components corresponding to F(H₂*) resulting from quantisation are substantially blocked by the filter. The first subset of apertures is preventing (blocking) light from passing, and the second subset of apertures is allowing light to pass. It will be appreciated that method 1400 may be continued for each light field required to cover a desired area of the Fourier plane, for example corresponding to an area of a viewer's pupil, and is not limited to only two light fields. Blocks may also be executed in a different order and/or in parallel.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A spatial filter for positioning in a Fourier plane of a holographic display system, the spatial filter delimiting a set of apertures, wherein each aperture in the set of apertures is switchable between a substantially transmissive and a substantially non-transmissive state, wherein:
the set of apertures comprises a plurality of subsets of apertures, each subset comprising at least one aperture;
each of the subsets of apertures corresponds to a Fourier transform of a target light field, F(H), wherein F(H) substantially does not overlap a Fourier transform of a complex conjugate of the corresponding target light field, F(H*), in the Fourier plane, and
the union of the set of apertures forms a shape which is at least one of simply connected and substantially space filling.

2. The spatial filter according to claim 1, wherein the shape is a simple polygon and/or is dodecagonal.

3. The spatial filter according to claim 1, wherein the shape can be substantially tessellated, or the shape can be substantially tessellated on a rhombic grid.

4. The spatial filter according to claim 1, wherein the shape has two-fold symmetry.

5. The spatial filter according to claim 1, wherein the shape substantially has the form of an “I” or “H”.

6. The spatial filter according to claim 1, wherein an aperture of the set of apertures is a quadrilateral.

7. The spatial filter according to claim 1, wherein a subset of apertures has an area approximately ⅙th of an area of a square on the grid formed by integer diffraction orders of light having a predetermined wavelength incident on a modulator.

8. The spatial filter according to claim 1, wherein:
at least one of the subsets of apertures corresponds to a Fourier transform of a first target light field, F(H) and further does not substantially overlap (i) a Fourier transform of the first target light field multiplied by the complex conjugate of the target light field, F(HH*), (ii) a Fourier transform of a square of the target light field, F(H²), and (iii) a Fourier transform of a square of the complex conjugate of the light field F(H*²).

9. A holographic display system comprising:
a light source configured to emit at least partially coherent light;
a modulator arranged to be illuminated by the at least partially coherent light and to generate a time sequence of light fields, wherein each of the light fields is a quantised representation of a target light field; and
a spatial filter according to claim 1 in a Fourier plane.

10. The holographic display system according to claim 9, wherein the modulator is a digital micromirror device.

11. The holographic display system according to claim 9, wherein the spatial filter is positioned so that the union of the set of apertures substantially aligns with a peak diffraction efficiency of the modulator.

12. The holographic display system according to claim 11, wherein the light source is configured to emit at least partially coherent light at a plurality of wavelengths selected so that the peak diffraction efficiency of the modulator approximately aligns in at least one direction with a respective integer diffraction order for each of the plurality of wavelengths.

13. The holographic display system according to claim 12, wherein the plurality of wavelengths comprises red, green and blue light and the peak diffraction efficiency for each of red, green and blue light is approximately aligned with a different integer diffraction order.

14. The holographic display system according to claim 13, wherein the peak diffraction efficiency is approximately aligned with the 5th, 6th and 7th vertical diffraction orders for red, green and blue respectively.

15. The holographic display system according to claim 9, further comprising:
an image replicating combiner positioned in an optical path after the spatial filter such that an input surface of the image-replicating combiner is positioned near the Fourier plane; and
a processing system coupled to the modulator and configured to:
determine a light field to be displayed at a viewing location;
determine a transfer function describing the propagation of light through the image-replicating combiner between the viewing location and the Fourier plane;
determine an input light field by applying the determined transfer function to the light field at the viewing location, wherein the input light field corresponds to the union of the set of apertures;
determine a plurality of F(H) corresponding to each of the subsets of apertures to be displayed at the Fourier plane from the input light field; and
cause the modulator to generate each of the plurality of F(H) at the input location.

16. The holographic display system according to claim 15, wherein the image replicating combiner generates a plurality of replications of the input light field, and wherein the plurality of replications approximately tesselate when viewed from at least one viewing position.

17. The holographic display system according to claim 15, further comprising an eye-tracking system arranged to provide data indicative of a viewing position to the processing system.

18. The holographic display system according to claim 9, wherein the light source is configured to emit at least partially coherent light at a plurality of wavelengths, including green light, and the apertures correspond to positions of respective F(H) for green light.

19. The holographic display system according to claim 9, comprising a controller configured to cause the modulator to display a time sequence of quantised target light fields, each of the time sequence of quantised target light fields corresponding to a respective one of the plurality of subsets of apertures, in substantial synchrony with the respective one of the plurality of subsets of apertures of the spatial filter being in a substantially transmissive state.

20. A non-transitory computer-readable medium comprising instructions, that, when executed by a processor, cause a holographic display system to display a holographic image, the holographic display system comprising a spatial filter positioned in a Fourier plane of the holographic display system, the spatial filter delimiting a set of apertures, wherein each aperture in the set of apertures is switchable between a substantially transmissive and a substantially non-transmissive state, wherein: the set of apertures comprises a plurality of subsets of apertures, each subset comprising at least one aperture; each of the subsets of apertures corresponds to a Fourier transform of a target light field, F(H), wherein F(H) substantially does not overlap a Fourier transform of a complex conjugate of the corresponding target light field, F(H*), in the Fourier plane, and the union of the set of apertures forms a shape which is at least one of simply connected and substantially space filling, the instructions causing the processor to:
determine a first light field, H₁, for quantisation, the first light field having a Fourier transform, F(H₁), such that it does not overlap a Fourier transform of its complex conjugate, F(H₁*);
determine a second light field, H₂, for quantisation, the second light field having a Fourier transform, F(H₂), such that it does not overlap a Fourier transform of its complex conjugate, F(H₂*);
at a first time, display a quantised version of the first light field using the holographic display system, wherein a first subset of apertures corresponds to an extent of F(H₁) in a Fourier plane such that components corresponding to F(H₁*) resulting from quantisation are substantially blocked by the filter; and
at a second time, display a quantised version of the second light field using the holographic display system, wherein a second subset of apertures corresponds to an extent of F(H₂) in a Fourier plane such that components corresponding to F(H₂*) resulting from quantisation are substantially blocked by the filter,
wherein at the first time, the first subset of apertures allows light to pass and the second subset of apertures prevents light from passing, and
at the second time, the first subset of apertures prevents light from passing and the second subset of apertures allows light to pass.
